(19) United States
(12) Patent Application Publication
(10) Pub. No.: US 2024/0203028 A1
(43) Pub. Date: Jun. 20, 2024

(54) METHOD AND SYSTEM FOR GENERATING DISPLAY IMAGES OF EFFECT COATINGS

(71) Applicant: BASF Coatings GmbH, Muenster (DE)

(72) Inventor: Guido BISCHOFF, Muenster (DE)

(21) Appl. No.: 18/558,037

(22) PCT Filed: May 17, 2022
(86) PCT No.: PCT/EP22/63304

§ 371 Date: Oct. 30, 2023

(30) Foreign Application Priority Data
May 31, 2021 (EP) 21176903.9

(51) Int. Cl. G06T 15/04; G06T 11/00; G06T 11/60; G06V 10/54; G06V 10/56

(52) U.S. Cl. CPC G06T 15/04; G06T 11/001; G06T 11/60; G06V 10/54; G06V 10/56

(57) ABSTRACT

Disclosed herein are methods and systems for generating display images of effect coatings. Further disclosed herein are methods and systems for ad-hoc generation of high quality images displaying the color as well as the texture of effect coating(s) without the use of rendering techniques using predefined illumination conditions and object data of virtual objects. The generated display images are especially suitable for assessing characteristics of effect coating(s) or for assessing color differences between two or more effect coating(s) based on the generated display images by arranging them side by side in horizontal order. It is also possible to transpose the display images by swapping the x- and y-axis of the images such that an optimized arrangement in vertical order, e. g. for mobile devices, is obtained.

### FIELD

Aspects described herein generally relate to methods and systems for generating display images of effect coatings. More specifically, aspects described herein relate to methods and systems for ad-hoc generation of high quality images displaying the color as well as the texture of effect coating(s) without the use of rendering techniques using predefined illumination conditions and object data of virtual objects. Instead, a visual 3D effect, i.e. the color travel associated with effect coating(s), is obtained by correlating an axis of a color image with an ordered list of measurement geometries prior to mapping the ordered list of measurement geometries and associated measured or scaled CIEL*a*b* values to the correlated row in the color image. A texture layer is added to the generated color image using an aspecular-dependent scaling function to reproduce the appearance of the texture with respect to different aspecular angles. Use of scaled L* values during color image generation avoids the loss of color hue information in the gloss region which is essential for performing visual color matching operations. The generated display images are especially suitable for assessing characteristics of effect coating(s) or for assessing color differences between two or more effect coating(s) based on the generated display images by arranging them side by side in horizontal order. It is also possible to transpose the display images by swapping the x- and y-axis of the images such that an optimized arrangement in vertical order, e. g. for mobile devices, is obtained.

### BACKGROUND

Paint finishes comprising effect pigments (also called effect coatings), such as metallic effect pigments and interference pigments, are widespread within the automobile industry. They provide a paint with additional properties such as angle-dependent changes in lightness and shade, i.e. the lightness or shade of the coating layer changes depending on the viewing angle of the observer, a visually perceptible granularity or graininess (also called coarseness) and/or sparkling effects. The visually perceptible coarseness and sparkling effects are also called the visual texture of an effect coating.

In general the visual impression of effect coatings strongly depends on the conditions used to illuminate the effect coating layer. Under directional illumination conditions (e.g. sunshine conditions) the angle-dependent changes in lightness and shade as well as the sparkle characteristics (for example sparkling effects) are dominant, while the coarseness characteristic (for example the visually perceptible graininess) is dominant under diffuse illumination conditions (e.g. cloudy weather conditions).

There are currently two techniques in use for characterizing coatings comprising effect pigments. The first technique uses a light source to illuminate the surface of the coating and to measure the spectral reflection at different angles. The chromaticity values, e.g., CIEL*a*b* values, can then be calculated from the obtained measurement results and the radiation function of the light source (see for example, ASTM E2194-14 (2017) and ASTM E2539-14 (2017). In the second technique, images of the surface of the coating are taken under defined light conditions and at defined angles. The texture parameters which quantify the visual texture are then calculated from the obtained images. Examples of such calculated texture parameters include the textural values G diffuse or Gdiff (so called graininess or coarseness or coarseness value or coarseness characteristic) which describes the coarseness characteristics of a coating layer under diffuse illumination conditions, Si (sparkle intensity), and Sa (sparkle area) which describe the sparkle characteristics of a coating layer under directional illumination conditions, as introduced by the company Byk-Gardner (“Den Gesamtfarbeindruck objektiv messen”, Byk-Gardner GmbH, JOT 1.2009, vol. 49, issue 1, pp. 50-52). The texture parameters introduced by Byk-Gardner are determined from gray scale images. It is also possible for texture parameters to be determined from color images, as e. g. introduced by the company X-Rite with the MA-T6 or MA-T12 multiangle spectrophotometers.

In colorimetric applications display images of effect coating(s) are commonly used to display important characteristics, such as the visual texture, on a digital display device, such as a computer screen, or to visually compare at least two displayed images of effect coating(s) with respect to the difference in color and/or texture. In many cases low resolution representations are sufficient to visualize the main characteristics of effect coating(s), for example if many images of effect coatings are displayed at the same time on one digital display device, eg. in tables or lists which may include color measurement data. However, high quality images are usually required for visual comparison of at least two effect coatings with respect to their color and/or visual texture. Such visual comparison is commonly performed during repair processes to select the best matching effect coating material such that the repaired area does not have a visually distinct color. While existing color tolerance models can be used in colorimetric applications to reliably identify best matching solid shade coating materials (i.e. coating materials not comprising any effect pigments), existing texture tolerance models are not universally applicable to the whole range of effect coating materials and can therefore not be used to reliably identify best matching effect coating materials. Thus, color matching of effect coatings still requires visual comparison of high-quality display images to identify the best matching effect coating in terms of color and visual texture.

Today methods are available which allow to generate high-quality display images of effect coatings based on 3D-rendering techniques. However, 3D-rendering techniques require a high computing power as well as object data of virtual object(s) and predefined illumination conditions to generated display images. Moreover, the output images often include a high level of detail and have a high resolution thus requiring bigger sized screens for a proper visualization.

It would therefore be desirable to provide resource efficient methods and systems for generating display images of effect coatings which are not associated with the aforementioned drawbacks. More specifically, the computer-implemented methods and systems for generation of display images of effect coating(s) should allow ad-hoc generation of display images having a low or high resolution and including all important characteristics of effect coating(s), i.e. the angle-dependent color travel as well as the visual texture, without the use of 3D-rendering techniques. The ad-hoc generation should require low hardware resources and should result in display images which are designed to be displayed on standard, i.e. non-HDR, screens of display devices and which are designed to allow a reliable visual comparison between different effect coatings.

### Definitions

“Appearance” refers to the visual impression of the coated object to the eye of an observer and includes the perception in which the spectral and geometric aspects of a surface is integrated with its illuminating and viewing environment. In general, appearance includes color, visual texture such as coarseness characteristics caused by effect pigments, sparkle characteristics, gloss, or other visual effects of a surface, especially when viewed from varying viewing angles and/or with varying illumination angles. The terms “graininess”, “coarseness”, “coarseness characteristics” and “coarseness values” are used as synonyms within the description. The term “texture characteristics” includes the coarseness characteristics as well as the sparkle characteristics of effect coating layers.

“Effect coating” refers to a coating, in particular a cured coating, comprising at least one effect coating layer. “Effect coating layer” refers to a coating layer, in particular a cured effect coating layer, comprising at least one effect pigment. “Effect pigment” refers to pigments producing an optical effect, such as a gloss effect or an angle-dependent effect, in coating materials and cured coating layers produced from the coating materials, said optical effect mainly being based on light reflection. Examples of effect pigments include lamellar aluminum pigments, aluminum pigments having a cornflake and/or silver dollar form, aluminum pigments coated with organic pigments, glass flakes, glass flakes coated with interference layers, gold bronzes, oxidized bronzes, iron oxide-aluminum pigments, pearlescent pigments, micronized titanium dioxide, metal oxide-mica pigments, lamellar graphite, platelet-shaped iron oxide, multilayer effect pigments composed of PVD films, liquid crystal polymer pigments and combinations thereof. The effect coating may consist of exactly one coating layer, namely an effect coating layer, or may contain at least two coating layers, wherein at least one coating layer is an effect coating layer. The coating layer(s) of the effect coating can be “prepared from the respective coating material by applying the coating material on an optionally coated substrate using commonly known application methods, such as pneumatic spray application or ESTA and optionally drying the applied coating material to form a coating film. The applied coating material or formed coating film may either be cured, for example by heating the applied or dried coating material, or at least one further coating material may be applied as previously described on the noncured (i.e. “wet”) coating material or film and all noncured coating materials or films may be jointly cured after application and optional drying of the last coating material. After curing, the obtained effect coating is no longer soft and tacky but is transformed into a solid coating which does not undergo any further significant change in its properties, such as hardness or adhesion on the substrate, even under further exposure to curing conditions.

“Display device” refers to an output device for presentation of information in visual or tactile form (the latter may be used in tactile electronic displays for blind people). “Screen of the display device” refers to physical screens of display devices and projection regions of projection display devices alike.

“Gloss measurement geometries” refers to measurement geometries with an associated aspecular angle of up to 30°, for example of 10° to 30°, the aspecular angle being the difference between the observer direction and the gloss direction of the measurement geometry. Use of these aspecular angles allows to measure the gloss color produced by the effect pigments present in the effect coating layer. “Non-gloss measurement geometries” refers to measurement geometries with associated aspecular angles of more than 30°, i.e. to all measurement geometries not being gloss measurement geometries, such as, for example, flop measurement geometries and intermediate measurement geometries described hereinafter. “Flop measurement geometries” refers to measurement geometries with an associated aspecular angle of more than 70°, for example of 70° to 110°, allowing to measure the angle-dependent color change of effect pigments present in the effect coating layer. “Intermediate geometry” refers to measurement geometries with associated aspecular angles of more than 30° to 70°, i.e. aspecular angles not corresponding to gloss measurement geometries and flop measurement geometries.

“Texture characteristics” refers to the coarseness characteristics and/or sparkle characteristics of an effect coating layer. The coarseness characteristics and the sparkle characteristics of effect coating layers can be determined from texture images acquired by multi-angle spectrophotometers as described in the following.

“Digital representation” may refer to a representation of an effect coating in a computer readable form. In particular, the digital representation of the effect coating includes CIEL*a*b* values of the effect coating obtained at a plurality of measurement geometries, wherein the plurality of measurement geometries includes at least one gloss measurement geometry and at least one non-gloss measurement geometry. The digital representation of the effect coating may further include texture image(s) of the effect coating, texture characteristics of the effect coating, such as coarseness characteristics and/or sparkle characteristics, the layer structure of the effect coating, the color name, the color number, the color code, a unique database ID, instructions to prepare the effect coating material(s) associated with the effect coating (e.g. mixing formulae), formulation(s) of the coating material(s) used to prepare the effect coating, color ratings, matching or quality scores, the price or a combination thereof.

“Scaled digital representation” refers to a digital representation of an effect coating where the L* values of the CIEL*a*b* values included in the digital representation have been scaled with a scaling factor s_{L}. The scaled digital representation(s) can thus be obtained from the digital representation(s) of the effect coating by multiplying all L* values included in said representation(s) with the scaling factor s_{L}.

“Communication interface” may refer to a software and/or hardware interface for establishing communication such as transfer or exchange or signals or data. Software interfaces may be e. g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

“Computer processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

“Data storage medium” may refer to physical and other computer-readable media for carrying or storing computer-executable instructions and/or data structures. Such computer-readable media can be any available media that can be accessed by a general-purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

“Database” may refer to a collection of related information that can be searched and retrieved. The database can be a searchable electronic numerical, alphanumerical, or textual document; a searchable PDF document; a Microsoft Excel® spreadsheet; or a database commonly known in the state of the art. The database can be a set of electronic documents, photographs, images, diagrams, data, or drawings, residing in a computer readable storage media that can be searched and retrieved. A database can be a single database or a set of related databases or a group of unrelated databases. “Related database” means that there is at least one common information element in the related databases that can be used to relate such databases.

“Client device” may refer to a computer or a program that, as part of its operation, relies on sending a request to another program or a computer hardware or software that accesses a service made available by a server.

### SUMMARY

To address the above-mentioned problems in a perspective the following is proposed: a computer-implemented method for displaying the appearance of at least one effect coating on the screen of a display device, said method comprising:
(i) providing to a computer processor via a communication interface at least one digital representation of an effect coating, each digital representation including CIEL*a*b* values of the effect coating obtained at a plurality of measurement geometries, wherein the plurality of measurement geometries includes at least one gloss measurement geometry and at least one non-gloss measurement geometry;
(ii) generating—with the computer processor—color image(s) by calculating corresponding CIEL*a*b* values for each pixel in each created image based on
   an ordered list of measurement geometries generated from the digital representation(s) provided in step (i) and
   the digital representation(s) provided in step (i) or—if at least one L*value included in at least one provided digital representation is greater than 90—scaled digital representation(s);
(iii) generating—with the computer processor—appearance data of the effect coating(s) by adding a texture layer pixel-wise to each generated color image using a lightness scaling factor s_{L}, an aspecular-dependent scaling function sf_{aspecular} and optionally a texture contrast scaling factor s_{c};
(iv) optionally repeating steps (ii) and (iii) with an ordered list of measurement geometries being different from the ordered list of measurement geometries used in step (ii);
(v) displaying on the screen of the display device the generated appearance data of the effect coating(s) received from the processor.

It is an essential advantage of the method according to the present invention that the generated display images show the main characteristics of effect coatings, i.e. the angle-dependent color travel (including the reflectance color from gloss and from flop observer directions) as well as the visual texture characteristics under different illumination conditions, and can be generated ad-hoc with low hardware resources, i.e. without the use of 3D rendering techniques. The angle-dependent color travel which is observed under directional illumination conditions (e.g. sunshine conditions) is obtained by using an ordered list of measurement geometries including gloss measurement geometries as well as non-gloss measurement geometries, while the visual impression of the effect coatings under diffuse illumination conditions (e.g. cloudy weather conditions) is obtained by using an ordered list of measurement geometries consisting of intermediate measurement geometries. A scaling factor is used to scale the L* values in case the measured lightness is higher than 90 to ensure that all color hue information is retained in areas having a high gloss. This allows to use the display images for visual comparison of the effect coatings because the retained information is essential to judge the degree of color matching. Displaying the measured texture images as texture layer provides additional information about the visual texture in comparison to texture values (like sparkle and coarseness values) because these texture values do only contain compressed information and do not provide spatially resolved information (e.g. distribution, size distribution, lightness distribution) or information on the color. The displayed appearance of the effect coatings is designed in a way which allows to optimally compare different effect coatings under the same illumination conditions by using an identical pixel resolution, lightness scaling factor and ordered list of measurement geometries during the generation of the appearance data which is to be compared and displaying the generated appearance data side by side in a horizontal arrangement such that each line of the arranged appearance data (i.e. display image) belongs to the same aspecular angle. The display images can also be transposed by swapping the x- and y-axis to allow for comparison of the images in a vertical arrangement, for example on the screen of a smartphone. The generated appearance data has a standard dynamic range (SDR) format so that no additional tone mapping is required to display the data as it would be necessary for high dynamic range (HDR) raw data.

Further disclosed is:
a system for displaying the appearance of an effect coating on the screen of a display device, said system comprising:
   a communication interface for providing at least one digital representation of an effect coating to a processor, each digital representation including CIEL*a*b* values of the effect coating obtained at a plurality of measurement geometries, wherein the plurality of measurement geometries includes at least one gloss measurement geometry and at least one non-gloss measurement geometry;
   a display device comprising a screen;
   optionally an interaction element for detecting a user input;
   a processor in communication with the communication interface, the interaction element and the display device, the processor programmed to:
      receive via the communication interface the at least one digital representation of an effect coating;
      generate color image(s) by calculating corresponding CIEL*a*b* values for each pixel in each created image based on
         an ordered list of measurement geometries generated from the received digital representation(s) and
         the received digital representation(s) or—if the lightness L* in at least one provided digital representation is greater than 90—scaled digital representation(s); and
      generate appearance data of the effect coating(s) by adding a texture layer pixel-wise to each generated color image using a lightness scaling factor s_{L}, an aspecular-dependent scaling function sf_{aspecular} and optionally a texture contrast scaling factor s_{c};

wherein the display device receives the generated appearance data of the effect coating(s) from the processor and displays the appearance of the effect coating(s).

The inventive system requires low hardware resources such that the computer processor can be located on a web server or on mobile devices like a smartphone. This allows to integrate the generated display images as preview images in colorimetric applications or to use the generated display images for color matching operations during repair operations within a colorimetric application without requiring client devices having high a computing power or special graphical resources.

Further disclosed is:

A non-transitory computer-readable storage medium, the computer-readable storage medium including instructions that when executed by a computer, cause the computer to perform the steps according to the computer-implemented methods described herein.

Further disclosed is the use of appearance data generated according to the method disclosed herein or generated with the system disclosed herein as button, icon, color preview, for color comparison and/or for color communication.

Further disclosed is a client device for generating a request to determine the appearance of an effect coating at a server device, wherein the client device is configured to provide a digital representation of at least one effect coating and optionally a texture layer to a server device.

The disclosure applies to the methods, systems and non-transitory computer-readable storage media disclosed herein alike. Therefore, no differentiation is made between methods, systems and non-transitory computer-readable storage media. All features disclosed in connection with the inventive method are also valid for the system and non-transitory computer-readable storage media disclosed herein.

### EMBODIMENTS

### Embodiments of the Inventive Method

In an aspect, the display device comprises an enclosure housing the computer processor performing steps (ii) and (iii) and the screen. The display device therefore comprises the computer processor and the screen. The enclosure may be made of plastic, metal, glass, or a combination thereof.

In an alternative aspect, the display device and the computer processor performing steps (ii) and (iii) are configured as separate components. According to this aspect, the display device comprises an enclosure housing the screen but not the computer processor performing steps (ii) and (iii) of the inventive method. The computer processor performing steps (ii) and (iii) of the inventive method is thus present separately from the display device, for example in a further computing device. The computer processor of the display device and the further computer processor are connected via a communication interface to allow data exchange. Use of a further computer processor being present outside of the display device allows to use higher computing power than provided by the processor of the display device, thus reducing the computing time necessary to perform these steps and thus the overall time until the generated color data is displayed on the screen of the display device. This allows to display the appearance of at least one effect coating layer, in particular of a plurality of effect coating layers, ad hoc without requiring a display device with high computing power. The further computer processor can be located on a server, such that steps (ii) and (iii) of the inventive method are performed in a cloud computing environment. In this case, the display device functions as client device and is connected to the server via a network, such as the Internet. Preferably, the server may be an HTTP server and is accessed via conventional Internet web-based technology. The internet-based system is in particular useful, if the service of displaying the appearance of at least one effect coating layer is provided to customers or in a larger company setup.

The display device may be a mobile or a stationary display device, preferably a mobile display device. Stationary display devices include computer monitors, television screens, projectors etc. Mobile display devices include laptops or handheld devices, such as smartphones and tablets.

The screen of the display device may be constructed according to any emissive or reflective display technology with a suitable resolution and color gamut. Suitable resolutions are, for example, resolutions of 72 dots per inch (dpi) or higher, such as 300 dpi, 600 dpi, 1200 dpi, 2400 dpi, or higher. This guarantees that the generated appearance data can displayed in a high quality. A suitably wide color gamut is that of standard Red Green Blue (sRGB) or greater. In various embodiments, the screen may be chosen with a color gamut similar to the gamut perceptible by human sight. In an aspect, the screen of the display device is constructed according to liquid crystal display (LCD) technology, in particular according to liquid crystal display (LCD) technology further comprising a touch screen panel. The LCD may be backlit by any suitable illumination source. The color gamut of an LCD screen, however, may be widened or otherwise improved by selecting a light emitting diode (LED) backlight or backlights. In another aspect, the screen of the display device is constructed according to emissive polymeric or organic light emitting diode (OLED) technology. In yet another aspect, the screen of the display device may be constructed according to a reflective display technology, such as electronic paper or ink. Known makers of electronic ink/paper displays include E INK and XEROX. Preferably, the screen of the display device also has a suitably wide field of view that allows it to generate an image that does not wash out or change severely as the user views the screen from different angles. Because LCD screens operate by polarizing light, some models exhibit a high degree of viewing angle dependence. Various LCD constructions, however, have comparatively wider fields of view and may be preferable for that reason. For example, LCD screens constructed according to thin film transistor (TFT) technology may have a suitably wide field of view. Also, screens constructed according to electronic paper/ink and OLED technologies may have fields of view wider than many LCD screens and may be selected for this reason.

The display device may comprise an interaction element to facilitate user interaction with the display device. In one example, the interaction element may be a physical interaction element, such as an input device or input/output device, in particular a mouse, a keyboard, a trackball, a touch screen or a combination thereof.

In an aspect of the inventive method, the effect coating consists of a single effect coating layer. The effect coating is formed by applying the effect coating material directly to an optionally pre-treated metal or plastic substrate, optionally drying the applied effect coating material, and curing the formed effect coating film.

In an alternative aspect, the effect coating comprises at least two coating layers, wherein at least one coating layer is an effect coating layer, such as a basecoat layer comprising at least one effect pigment, and the at least one further coating layer is a further basecoat layer and/or a tinted clearcoat layer and/or a clearcoat layer. “Basecoat layer” may refer to a cured color-imparting intermediate coating layer commonly used in automotive painting and general industrial painting. “Tinted clearcoat layer” may refer to a cured coating layer which is neither completely transparent and colorless as a clear coating nor completely opaque as a typical pigmented basecoat. A tinted clearcoat layer is therefore transparent and colored or semi-transparent and colored. The color can be achieved by adding small amounts of pigments commonly used in basecoat coating materials. The basecoat material used to prepare the basecoat layer comprising at least one effect pigment is formulated as an effect coating material. Effect coating materials generally contain at least one effect pigment and optionally other colored pigments or spheres which give the desired color and effect. The basecoat material used to prepare the further basecoat layer is formulated as an effect coating material or as a solid coating material (i.e. a coating material only comprising coloring pigments and being free of any effect pigments). In one example, the effect coating is formed by applying the effect basecoat material to a metal or plastic substrate comprising at least one cured coating layer, optionally drying the applied effect basecoat material and curing the effect basecoat material. In another example, the effect coating is formed by applying the effect basecoat material to a metal or plastic substrate optionally comprising at least one cured coating layer and optionally drying the applied effect basecoat material. Afterwards, at least one further coating material (i.e. further basecoat material or tinted clearcoat material or clearcoat material) is applied over the noncured or “wet” effect basecoat layer (“wet-on-wet” application) and optionally dried. After the last coating material has been applied wet-on-wet, the basecoat layer and all further coating layer are jointly cured, in particular at elevated temperatures.

In an aspect, steps (ii), (iii) and (v) are performed simultaneously. “Simultaneously” refers to the time it takes the computer processor to perform steps (ii) and (iii) and the display device to display the generated appearance data. Preferably, the time is small enough such that the appearance data can be generated and displayed ad-hoc, i.e. within a few milliseconds after initiating step (ii).

In step (i) of the inventive method, at least one digital representation of an effect coating is provided. This step may thus include providing exactly one digital representation of an effect coating or providing at least two digital representations of effect coatings. The number of digital representations of effect coatings provided in step (i) is guided primarily by the use of the displayed appearance data and is not particularly limited.

Each digital representation provided in step (i) includes CIEL*a*b* values of the respective effect coating obtained at a plurality of measurement geometries including at least one gloss measurement geometry and at least one non-gloss measurement geometry. When a color is expressed in CIELAB, “L” defines lightness, “a” denotes the red/green value and “b” the yellow/blue value.

In one example, each digital representation of the effect coating may—apart from the CIEL*a*b* values previously mentioned—further comprise texture image(s) of the effect coating, texture characteristics of the effect coating, such as coarseness characteristics and/or sparkle characteristics, the layer structure of the effect coating, the color name, the color code, a unique database ID, a bar code, a QR code, mixing formulae, formulation(s) of the coating material(s) used to prepare the effect coating, a color ranking, a matching or quality score, a price, or a combination thereof. Texture images as well as the texture characteristics, i.e. the coarseness characteristics and/or the sparkle characteristics, can be obtained using a commercially available multi-angle spectrophotometer by acquiring grey scale or color images (i.e. texture images) of the effect coating under defined illumination conditions and at defined angles and calculating the coarseness characteristics and/or sparkle characteristics from the acquired texture images as previously described (e. g. a Byk-Mac® I or a spectrometer of the XRite MA®-T-family). In another example, the texture image(s), texture characteristics, the color name, the color code, a bar code, a QR code, mixing formulae, formulation(s) of the coating material(s) used to prepare the effect coating, a color ranking, a matching or quality score or a price may be stored in a database and may be retrieved based on further meta data inputted by the user or based on the provided digital representation of the effect coating, in particular based on the CIEL*a*b* values contained in said representation.

In an aspect, providing at least one digital representation of the effect coating comprises
determining CIEL*a*b* values and optionally texture image(s) and/or texture characteristics of an effect coating at a plurality of measurement geometries with a measuring device and providing the determined CIEL*a*b* values, the determined texture images(s) and texture characteristics and the used measurement geometries optionally in combination with further meta data and/or user input via the communication interface to the computer processor, and
optionally obtaining at least one further digital representation of an effect coating based on the provided determined CIEL*a*b* values and optionally based on the determined texture image(s) and/or texture characteristics and/or further meta data and/or user input and providing the obtained at least one further digital representation of the effect coating via the communication interface to the computer processor.

The CIEL*a*b* values of an effect coating at a plurality of measurement geometries can be determined using commercially available multi-angle spectrometers such as a Byk-Mac® I or a spectrometer of the XRite MA®-T-family. For this purpose, reflectance of the respective effect coating is measured for several geometries, namely with viewing angles of −15°, 15°, 25°, 45°, 75° and 110°, each measured geometry being relative to the specular angle. The multi-angle spectrophotometer is preferably connected to a computer processor which is programmed to process the measured reflectance data, for example by calculating the CIEL*a*b* values for each measurement geometry from the measured reflectance at the respective measurement geometry. The determined CIEL*a*b* values may be stored on a data storage medium, such as an internal memory or a database prior to providing the determined CIEL*a*b* values via the communication interface to the computer processor. This may include interrelating the determined CIEL*a*b* values with meta data and/or user input prior to storing the determined CIEL*a*b* values such that they can be retrieved using the meta data and/or user input if needed.

The texture image(s) of the effect coating at a plurality of measurement geometries can be determined/acquired using commercially available multi-angle spectrometers such as a Byk-Mac® I or a spectrometer of the XRite MA®-T-family. The acquired texture images (grey scale or color images) can then be used to determine the coarseness characteristics (e.g. Gdiff) and sparkle characteristics (e.g. Si, Sa) as previously described. The determined texture image(s) and/or the determined texture characteristics may be stored on a data storage medium, such as an internal memory or a database, prior to providing the texture image(s) and/or the texture characteristics via the communication interface to the computer processor. This may include interrelating the determined texture image(s) and texture characteristics with meta data and/or user input prior to storing the images and characteristics such that they can be retrieved using the meta data and/or user input if needed. In one example, the texture image(s) as well as the texture characteristics are stored. In another example, only the determined texture characteristics are stored. Storing the determined CIEL*a*b* values, texture image(s) and/or texture characteristics may be preferred if said data is needed several times since the data does not have to be acquired each time the appearance of the respective effect coating is to be displayed on the screen of a display device.

Further meta data and/or user input may include the previously listed layer structure of the effect coating, color name, color code, unique database ID, bar code, QR code, mixing formulae, formulation(s) of coating material(s) used to prepare the effect coating, color ranking, quality score or a combination thereof.

In case the appearance of at least two effect coatings is to be displayed for the purpose of color matching, at least one further digital representation of an effect coating is obtained based on the provided determined CIEL*a*b* values and optionally based on the determined texture image(s) and/or texture characteristics and/or further user input and/or meta data and is provided via the communication interface to the computer processor. In this case, the determined CIEL*a*b* values correspond to the target color and the further digital representations and associated CIEL*a*b* values correspond to matching colors or color solutions. The number of obtained further digital representations may vary depending on the purpose of color matching but generally includes at least two further digital representations, such as the digital representation being associated with the best matching color and a digital representation being associated with a matching color and being frequently or recently used by the user or having been recently included in the database. In one example, the number of obtained further digital representations may be determined based on a predefined color tolerance threshold and/or a predefined texture tolerance threshold. In another example, the number of obtained further digital representations is fixed to a predefined number, such as 2.

Obtaining at least one further digital representation of an effect coating based on the provided determined CIEL*a*b* values and optionally based on the determined texture image(s) and/or texture characteristics and/or further meta data and/or user input may include determining with the computer processor best matching colorimetric values, in particular best matching CIEL*a*b* values. In one example, the computer processor determining best matching colorimetric values, in particular CIEL*a*b* values, is the computer processor used in steps (ii) and (iii). In another example, the computer processor determining best matching colorimetric values is a different computer processor, such as a computer processor located in a further computing device. The further computing device may be a stationary local computing device or may be located in a cloud environment as previously described. Use of a further computing device to determine best matching colorimetric values allows to shift the steps requiring high computing power to external computing devices, thus allowing to use display devices with low computing power without unreasonably prolonging the generation and display of appearance data on the screen of the display device.

Best matching colorimetric values, in particular CIEL*a*b* values, may be determined by determining best matching color solution(s) and associated matching colorimetric values, in particular CIEL*a*b* values, calculating the color differences between the determined CIEL*a*b* values and each matching colorimetric values, in particular matching CIEL*a*b* values, to define color difference values and determine if the color difference values are acceptable. The best matching color solution(s) and associated matching colorimetric values, in particular CIEL*a*b* values, may be determined by searching a database for the best matching color solution(s) based on the determined CIEL*a*b* values and/or the provided digital representation. In one example, the acceptability of the color difference values can be determined using a data driven model parametrized on historical colorimetric values, in particular CIEL*a*b* values, and historical color difference values. Such models are described, for example, in US 2005/0240543 A1. In another example, a commonly known color tolerance equation, such as the CIE94 color tolerance equation, the CIE2000 color tolerance equation, the DIN99 color tolerance equation or a color tolerance equation described in WO 2011/048147 A1, is used to determine the color difference values.

In an alternative aspect, providing at least one digital representation of the effect coating comprises providing effect coating identification data, obtaining the digital representation of the effect coating based on the provided effect coating identification data and providing the obtained digital representation. This aspect is preferred, if predefined or previously determined colorimetric values are used to generate appearance data of effect coatings. The digital representation of the effect coating may be obtained by retrieving the digital representation of the effect coating based on the provided effect coating identification data and providing the retrieved digital representation via the communication interface to the computer processor. Effect coating identification data may include color data of the effect coating, color data of the effect coating with a color and/or texture offset, data being indicative of the effect coating or a combination thereof. Color data can be colorimetric values, such as CIEL*a*b* values, texture characteristics or a combination thereof. The color data can be determined with a multi-angle spectrophotometer as previously described. The color data can be modified by using a color and/or texture offset, for example to lighten or to darken the color. Data being indicative of the effect coating may include a color name, a color code, the layer structure of the effect coating, a QR code, a bar code or a combination thereof. The effect coating identification data may either be inputted by the user via a GUI displayed on the screen of the display device, retrieved from a database based on scanned code, such as a QR code, or may be associated with a pre-defined user action. Predefined user actions may include selecting a desired action on the GUI displayed on the screen of the display device, such as, for example, displaying a list of stored measurements including associated images or displaying a list of available effect coatings according to searching criteria, user profile, etc.

The at least one digital representation of the effect coating provided in step (i) comprises a plurality of measurement geometries including at least one gloss measurement geometry and at least one non-gloss measurement geometry. The at least one gloss measurement geometry preferably includes aspecular angles of 10° to 30°, in particular of 15° and 25°. The at least one non-gloss measurement geometry preferably includes aspecular angles of greater or equal to 40°, preferably of 70° to 110°, in particular of 75°. The plurality of measurement geometries preferably includes aspecular angles of 10 to 110°, preferably of 10° to 80°, in particular of 15°, 25°, 45° and 75°.

In an aspect, step (i) further includes displaying the provided digital representation(s) of the effect coating on the screen of the display device. In one example this may include displaying the determined CIEL*a*b* values and optionally further meta data and/or user input on the screen of the display device. In another example this may include displaying the color associated with the determined CIEL*a*b* values and optionally further meta data and/or user input on the screen of the display device.

In step (ii) of the inventive method, color image(s) are generated for each provided digital representation by calculating corresponding CIEL*a*b* values for each pixel in each created image based on an ordered list of measurement geometries and the provided digital representation(s) or scaled digital representation(s).

In an aspect, all created images and therefore also the color image(s) generated therefrom have an identical resolution. This is particularly preferred if the generated appearance data is to be used for color matching purposes or if it is to be displayed within a list requiring a predefined resolution for each image appearing in the list. Preferably an identical resolution in the range of 160×120 pixels to 720×540 pixels, in particular an identical resolution of 480×360 pixels is used. Creating an image having a defined resolution includes creating an empty image by defining the number of pixels in the x- and y-direction. The created image(s) are then used to generate the color image as described in the following.

In an aspect, calculating the corresponding CIEL*a*b* values for each pixel in each created image includes correlating one axis of each created image with the generated ordered list of measurement geometries and mapping the ordered list of measurement geometries and associated digital representation or scaled digital representation, in particular the associated CIEL*a*b* values or scaled CIEL*a*b* values, to the correlated row in the created image.

In case at least two provided digital representations are to be compared to each other, calculating the corresponding CIEL*a*b* values for each pixel in each created image may include using an identical generated ordered list of measurement geometries for said provided digital representations. This allows to visually compare the generated appearance data because each line in the displayed appearance data (e.g. the display images) belongs to the same measurement geometry (e.g. the same aspecular angle) if the generated appearance data is displayed side by side in a horizontal arrangement.

The ordered list of measurement geometries may be generated from the provided digital representation(s) by
selecting at least one pre-defined measurement geometry from the plurality of measurement geometries contained in each provided digital representation and optionally sorting the selected measurement geometries according to at least one pre-defined sorting criterium if more than one measurement geometry is selected, and
optionally calculating the accumulated delta aspecular angle for each selected measurement geometry if more than one measurement geometry is selected.

Preferably, the at least one predefined measurement geometry includes at least one gloss measurement geometry and at least one non-gloss measurement geometry or at least one, in particular exactly one, intermediate measurement geometry. The at least one intermediate measurement geometry preferably corresponds to an aspecular angle of 45°. In the first case, at least two pre-defined measurement geometries are selected from the plurality of measurement geometries contained in each provided digital representation, namely at least one gloss and at least one non-gloss measurement geometry. In this case, the selected measurement geometries are sorted according to at least one pre-defined sorting criterium. In the latter preferred case, exactly one pre-defined measurement geometry, namely an intermediate measurement geometry, is selected from the plurality of measurement geometries contained in each provided digital representation. In this case, a sorting of the pre-defined measurement geometry is not necessary.

The at least one pre-defined sorting criterium may include a defined order of measurement geometries. This defined order of measurement geometries is preferably selected such that a visual 3D impression is obtained if the color image resulting from step (ii) is displayed on the screen of the display device. Examples of suitable 3D impressions include visual impressions of bend metal sheets.

Examples of defined orders of measurement geometries include 45°>25°>15°>25° >45°>75° and −15°>15°>25°>45°>75°>110°. Use of these defined orders of measurement geometries results in color images displaying the color travel of the effect coating layer under directional illumination conditions.

The at least one pre-defined measurement geometry and/or the at least one pre-defined sorting criterium may be retrieved by the computer processor from a data storage medium based on the provided digital representation(s) of the effect coating and/or further data. Further data may include data on the user profile or data being indicative of the measurement device and the measurement geometries associated with the measurement device.

An example of an ordered list of measurement geometries, associated aspecular angles, delta aspecular angles and accumulated aspecular angles is listed in the following table:

| Oder | Aspecular | Delta | Accumulated delta |
|---|---|---|---|
| position | angle | aspecular angle | aspecular angle |
| 1 | 45° | 0 | 0 |
| 2 | 25° | 20 | 20 |
| 3 | 15° | 10 | 30 |
| 4 | 25° | 10 | 40 |
| 5 | 45° | 20 | 60 |
| 6 | 75° | 30 | 90 |

The delta aspecular angle for each measurement geometry is the absolute difference angle between the aspecular angle associated with a selected measurement geometry, for example the aspecular angle of 45°, and the aspecular angle associated with the following selected measurement geometry, in this example an aspecular angle of 25°. The accumulated delta aspecular angle can be obtained by adding the delta aspecular angle associated with a selected measurement geometry, for example the delta aspecular angle associated with 25°, to the delta aspecular angle associated with the following selected measurement geometry, in this case the delta aspecular angle associated with 15° and repeating this step for each measurement geometry in the ordered list.

Step (ii) of the inventive method may include using scaled digital representation(s) to generate the color image(s) in case at least one L* value included in the provided digital representations is higher than 90. With preference, step (ii) may include using scaled digital representation(s) in case at least one L*value included in the provided digital representation(s) is higher than 95, in particular higher than 99. Each scaled digital representation may be obtained prior to generating the color image(s) by scaling all L* color values included in the digital representations provided in step (i) using at least one lightness scaling factor s_{L}. Use of this scaling factor allows to retain the color information contained in the gloss measurement geometries by compressing the color space while the existing color distances are kept constant. If no color space compression would be performed, L* values of more than 90, preferably with more than 95, in particular with more than 99, would be displayed with a cropped hue as almost or purely white, i.e. devoid of equidistantancy of color information which may be present in the a* and b* values associated with these L* values. However, the color information contained in the gloss measurement geometries is essential to identify the best matching color solution when performing visual color matching, for example during refinish operations.

In case at least two provided digital representations are compared to each other, the same lightness scaling factor s_{L} is preferably used to scale all L* color values included in said provided digital representations. This guarantees that any visual differences in the generated appearance data, in particular in the regions associated with gloss measurement geometries, is not due to the use of different lightness scaling factors S_{L} and thus results in generated appearance data being optimized for visual comparison of at least two different effect coating layers.

The lightness scaling factor s_{L} may be based on the maximum measured L* value of the CIEL*a*b* values included in all provided digital representations or based on the maximum measured L*value of the CIEL*a*b* values included in all provided digital representations which are to be compared to each other. This allows to retain the color information in the gloss region for digital representations comprising L* values of more than 90 as previously described.

The lightness scaling factor s_{L} can be obtained according to formula (1)

$${s}_{L} = \frac{x}{{L}_{max}} \qquad ( 1 )$$

in which
x ranges from 90 to 100, preferably from 95 to 100, very preferably from 95 to 99, and Lₘₐₓ is the maximum measured L* value of the CIEL*a*b* values included in all provided digital representations or the maximum measured L*value of the CIEL*a*b* values included in all provided digital representations which are to be compared to each other.

In an aspect, calculating corresponding CIEL*a*b* values for each pixel in each created image includes using an interpolation method, in particular a spline interpolation method. The interpolation method allows to calculate the intermediate CIEL*a*b* values, i.e. the CIEL*a*b* values for pixels which are not associated with measured geometries. Use of a spline interpolation method results in smooth transitions between CIEL*a*b* values for pixels associated with a measured geometry and intermediate CIEL*a*b* values.

Step (ii) may further include converting the calculated CIEL*a*b* values to sRGB values and optionally storing the sRGB values on a data storage medium, in particular an internal memory. Conversion of the calculated CIEL*a*b* values to sRGB values allows to display the calculated color information with commonly available display devices which use sRGB files to display information on the screen.

Step (ii) may further include displaying the generated color image(s) on the screen of the display device, optionally in combination with further meta data and/or user input.

In step (iii) of the inventive method, appearance data of the effect coating(s) is generated by adding a texture layer pixel-wise to each generated color image using a lightness scaling factor s_{L}, an aspecular-dependent scaling function sf_{aspecular} and optionally a texture contrast scaling factor s_{c}. The combination of the generated color image(s) with a texture layer provides additional information about the visual texture in comparison to a combination of color image(s) and texture values (like sparkle and coarseness values) because these texture values do only contain compressed information and do not provide spatially resolved information (e.g. distribution, size distribution, lightness distribution) or information on the color. The appearance data of effect coating layer(s) displayed on the screen of the display device in step (v) of the inventive method therefore contains the main characteristics of the effect coating(s), i.e. the viewing angle-dependent color travel and visual texture, and is thus especially suitable to produce high-quality display images for visual color matching or for display within lists.

The lightness scaling factor s_{L} used in step (iii) preferably corresponds to the lightness scaling factor s_{L} used in step (ii), i.e. the same lightness scaling factor s_{L} is preferably used in steps (ii) and (iii), or is 1 in case no lightness scaling factor s_{L} used in step (ii). Use of the same lightness scaling factor s_{L} in step (iii) allows to adjust the lightness of the texture image to the lightness of the color image, thus preventing a mismatch of the color and texture information with respect to lightness.

The aspecular-dependent scaling function sf_{aspecular} used in this step weights each pixel of the texture layer in correlation with the aspecular angles corresponding to the measurement geometries present in generated ordered list of measurement geometries. This allows to weight the pixels of the texture layer in correlation with the visual impression of the effect coating layer under different measurement geometries and therefore results in generated appearance data closely resembling the visual impression of the effect coating layer when viewed from different viewing angles by an observer. In general, the visual texture, i.e. the coarseness characteristics and the sparkle characteristics, is more prominent in the gloss measurement geometries than in the flop geometries. To take this into account, the aspecular-dependent scaling function sf_{aspecular} preferably outputs scaling factors S_{aspec} close to 1 for gloss measurement geometries and scaling factors S_{aspec} close to 0 for flop measurement geometries.

Examples of suitable aspecular-dependent scaling functions sf_{aspecular} for ordered lists comprising at least one non-gloss and at least one gloss measurement geometry include the functions of formulae (2a) or (2b)

$${sf}_{aspecular} = \frac{( {aspecular}_{max} - aspecular )}{{aspecular}_{max}} \qquad ( 2 a )$$

$${sf}_{aspecular} = {( \frac{( {aspecular}_{max} - aspecular )}{{aspecular}_{max}} )}^{2} \qquad ( 2 b )$$

in which
aspecularₘₐₓ is the measurement geometry in the ordered list corresponding to the highest aspecular angle, and
aspecular is the respective measurement geometry of a pixel of the texture layer.

For ordered lists consisting of only one measurement geometry or intermediate measurement geometries (i.e. not comprising any gloss and flop measurement geometries), an aspecular-dependent scaling function sf_{aspecular} of Sf_{aspecular}=1 is used.

Use of the texture contrast scaling factor s_{c} which acts as a hyper parameter to control the visual contrast of the texture is generally optional in step (iii) of the inventive method. If no texture contrast scaling is desired, the scaling factor is either not used or has a fixed value of 1. With particular preference, a texture contrast scaling factor s_{c} of 1 is used for acquired texture images such that the original “intrinsic” texture contrast of the acquired texture image is used in step (iii). If scaling of the “intrinsic” texture contrast is desired, for example by increasing or decreasing the texture contrast, the contrast scaling factor can assume values lower than 1 (e.g. to decrease the contrast) or values of higher than 1 (e.g. to increase the contrast). Increasing or decreasing the texture contrast may be performed to visualize a color difference, for example by changing at least part of the ingredients present in the effect coating material(s) used to prepare the respective effect coating. Moreover, increasing or decreasing the texture contrast may be performed in step (iii) if the generated appearance data is used within the acquisition of customer feedback on proposed color matching solutions to provide a better guidance to the customer during answering the feedback questions.

In an aspect, adding a texture layer pixel-wise to the generated color image(s) using a lightness scaling factor s_{L}, an aspecular-dependent scaling function sf_{aspecular} and optionally a texture contrast scaling factor s_{c} includes
providing at least one acquired or synthetic texture image,
generating modified texture image(s) by computing the average color of each provided acquired or synthetic texture image and subtracting the average color from the respective provided acquired or synthetic texture image, and
adding the respective modified texture image pixel-wise weighted with the lightness scaling factor s_{L}, the aspecular dependent scaling function sf_{aspecular} and optionally the contrast scaling factor so to the respective generated color image.

“Acquired texture image” refers to texture images, such as grey scale or color images, which have been acquired using a multi-angle spectrophotometer as previously described. In contrast, the term “synthetic texture image” refers to a texture image which has been generated from texture characteristics, such as the coarseness and/or sparkle characteristics, which can be determined from the acquired texture images as previously described.

The at least one acquired texture image may be provided by retrieving an acquired texture image, in particular the texture image acquired at a measurement geometry of 15°, from the provided digital representation(s) of the effect coating layer or by retrieving an acquired texture image, in particular the texture image acquired at a measurement geometry of 15°, from a data storage medium based on the provided digital representation(s) and optionally providing the retrieved texture image. Use of the texture image acquired at a measurement geometry of 15° is preferable because the visual texture is most pronounced at this measurement geometry. However, it may also be possible to retrieve a texture image acquired at any other measurement geometry. If acquired texture images are available, it is preferred within the inventive method to use an acquired texture image, preferably the texture image acquired at a measurement geometry of 15°, because the displayed appearance of the effect coating layer is more realistic as compared to the displayed appearance resulting from the use of synthetic texture images generated as described in the following.

The at least one synthetic texture image may be provided by
creating an empty image,
providing a target texture contrast cᵥ,
generating a random number by a uniform or a gaussian random number generator between −cᵥ and +cᵥ for each pixel in the created image and adding the generated random number to each pixel in the created image,
blurring the resulting image using a blur filter, in particular a gaussian blur filter, and
optionally providing the resulting synthetic texture image.

The synthetic texture image therefore corresponds to a texture image which has been “reconstructed” from the texture characteristics. Since the use of synthetic texture images to generate appearance data results in a less realistic appearance of the effect coating layer, acquired texture images are preferably used. However, if acquired texture images are not available, synthetic texture images are used as texture layer to provide additional information besides the numerical texture characteristics, such as spatially resolved texture information (e.g. distribution, size distribution, lightness distribution). The synthetic texture image may be created with the computer processor performing step (iii) or may be created with a further computer processor located on a local computing unit or in a cloud environment. In the latter case, the generated synthetic texture image has to be provided via a communication interface to the computer processor performing step (iii) of the inventive method.

The created empty image preferably has the same resolution as the color image generated in step (ii) to prevent mismatch of the texture layer upon addition of the texture layer to the generated color image. This also renders downscaling of the texture layer prior to addition of the said layer to the color image(s) superfluous.

In one example, the target texture contrast cᵥ is provided by retrieving the determined coarseness and/or sparkle characteristics from the provided digital representation(s) of the effect coating layer and optionally providing the retrieved coarseness and/or sparkle characteristics, in particular coarseness characteristics, as target texture contrast cᵥ. In this example, the coarseness characteristics and/or sparkle characteristics are therefore correlated with the texture contrast cᵥ.

In another example, the target texture contrast cᵥ is provided by retrieving the target texture contrast cᵥ from a data storage medium based on the provided digital representation(s) of the effect coating layer and optionally providing the retrieved target texture contrast cᵥ. This may be preferred if the provided digital representation(s) does/do not contain coarseness and/or sparkle characteristics and the coarseness and/or sparkle characteristics for the respective effect coating layer are also not available from other data sources, such as databases. The target texture contrast cᵥ may be stored in a database and may be interrelated with the respective digital representation. Suitable target texture contrast values cᵥ may be obtained by defining different categories, each category being associated with a specific target texture contrast cᵥ. In one example, the categories may be based on the amount of aluminum pigments being present in the coating formulation used to prepare the respective effect coating layer.

The provided acquired or synthetic texture image is modified by computing the average color of each provided acquired or synthetic texture image and subtracting the computed average color from the respective provided acquired or synthetic texture image. In one example, the average color of each provided acquired or synthetic texture image is computed by adding up all pixel colors of the provided acquired or synthetic texture image and diving this sum by the number of pixels of the provided acquired or synthetic texture image. In another example, the average color of each provided acquired or synthetic texture image can be computed by computing the pixel-wise local average color, in particular computing the pixel-wise local average color with a normalized box linear filter. The local average color of a pixel corresponds to the summation over all pixel colors under a specific image kernel area divided by the number of pixels of the kernel area and is commonly used in image processing (see for example P. Getreuer, A Survey of Gaussian Convolution Algorithms, Image Processing On Line, 3 (2013), pages 286 to 310, http://dx.doi.org/10.5201/ipol.2013.87). Use of the pixel-wise local average color allows to compensate lighting irregularities, for example if the provided acquired or synthetic texture image is darker at the edge than in the center due to the used measurement conditions, and thus provides modified texture images which more closely resemble the real appearance of the effect coating layer when viewed by an observer under different illumination conditions.

The respective modified texture image is afterwards added pixel-wise weighted with the lightness scaling factor s_{L}, the aspecular dependent scaling function sf_{aspecular} and optionally the texture contrast scaling factor so to the generated color image(s). This addition may be performed according to formula (3)

$$AI ( X , Y ) = CI ( X , Y ) + {s}_{L} * {s}_{C} * {sf}_{aspecular} * modified TI ( X , Y ) \qquad ( 3 )$$

in which
AI (X,Y) is the image resulting from addition of the texture layer to the respective generated color image,
CI (X,Y) is the generated color image,
s_{L} corresponds to the lightness scaling factor used to generate the respective color image or is 1 in case no lightness scaling factor is used to generate the respective color image,
s_{c} is the contrast scaling factor,
sƒ_{aspecular} is the aspecular-dependent scaling function, and
modified TI (X,Y) is the modified texture image.

In optional step (iv) of the inventive method, steps (ii) and (iii) are repeated with an ordered list of measurement geometries being different from the ordered list of measurement geometries generated during the first run of step (ii), i.e. the ordered list of measurement geometries generated upon repetition of step (ii) is different from the ordered list of measurement geometries generated during the first run of step (ii). In one example, an ordered list of measurement geometries comprising at least one non-gloss and at least one gloss geometry is used in the first run and an ordered list of measurement geometries consisting of intermediate geometries is used upon repeating steps (ii) and (iii). In another example, an ordered list of measurement geometries consisting of intermediate geometries is used in the first run and an ordered list of measurement geometries including at least one non-gloss and at least one gloss geometry is used upon repeating steps (ii) and (iii). This allows to generate appearance data under different illumination directions, such as directional illumination conditions (including gloss as well as flop measurement geometries) and diffuse illumination conditions (only including intermediate measurement geometries). Thus, the appearance data can be generated and displayed for different illumination conditions including sunshine conditions and cloudy weather conditions, allowing to increase user comfort because the user is able to get an impression on the appearance of the effect coating layer under different real life illumination conditions. Generating and displaying the appearance data under different illumination conditions also allows to increase the accuracy of visual color matching because the displayed appearance data can be compared under different illumination conditions, thus allowing to identify the best match considering all real-life illumination conditions.

In step (v) of the inventive method, the generated appearance data of the effect coating layer(s) received from the processor is displayed on the screen of the display device. The data may be displayed within a GUI being present on the screen of the display device. The GUI may allow the user to perform further actions, for example to enter data, such as comments, quality scores, rankings etc., save the generated appearance data optionally in combination with the entered data or retrieve further information from a database based on the provided digital representation used to generate the displayed appearance data, for example mixing formulae associated with the appearance data selected as best color match by the user.

With particular preference, neither step (iii) nor step (v) includes using 3D object data of a virtual object and optionally pre-defined illumination conditions, i.e. steps (iii) and (v) are not performed using commonly known rendering techniques, such as image-based lightning. Even though steps (iii) and (v) are not performed using commonly known rendering techniques, a 3D impression is nevertheless obtained by the inventive method. The 3D impression is, however, not due to the use of virtual object data but arises from the use of an ordered list of measurement geometries including at least one non-gloss and at least one gloss geometry to generate the color image(s) for each provided digital representation of the effect coating.

In an aspect, step (v) includes displaying the generated appearance data which is to be compared in a horizontal arrangement or transposing the generated appearance data which is to be compared and displaying the transposed appearance data in a vertical arrangement. Displaying the generated appearance data which is to be compared side by side in a horizontal arrangement allows to optimally compare the appearance of at least two effect coatings because each line of the displayed appearance data (i.e. the display images) belongs to the same measurement geometry (i.e. the same aspecular angle). Instead of displaying the generated appearance data in a horizontal arrangement, the generated appearance data (i.e. the display images) can also be transposed by swapping the x- and y-axis to allow for a visual comparison in a vertical arrangement, such as on the screen of a smartphone.

In an aspect, step (v) includes displaying at least part of the generated appearance data in case steps (ii) and (iii) are repeated. This allows to define if all generated appearance data obtained after repeating steps (ii) and (iii) is to be displayed or if only part of the generated appearance data is to be displayed. In one example, only the appearance data generated upon repeating steps (ii) and (iii) may be displayed such that the user only sees the currently generated appearance data. However, the appearance data generated in the previous run of steps (ii) and (iii) may have been stored on a data storage medium and the user may return to the previously displayed appearance data by clicking on the respective button on the GUI.

In an aspect, step (v) includes updating the displayed appearance data in case steps (ii) to (iv) are repeated. This allows to display changes in the appearance data, for example by using a different list of ordered measurement geometries or by using a different texture layer.

In an aspect, step (v) includes displaying data associated with the effect coating. Data associated with the effect coating includes, for example, the color name, the color identification number or color code, the layer structure of the effect coating, a color ranking, a matching or quality score, mixing formula, formulation(s) of the coating materials required to prepare the effect coating, a price, a color or texture tolerance (in case color matching is performed) or a combination thereof. This data may either be included in the provided digital representation(s), may be retrieved from a data storage medium based on the provided digital representation(s) of the effect coating or may be generated during generation of the appearance data. The data may be displayed on a GUI and the GUI may comprise additional functionalities as previously described to increase user comfort. Displaying further data may include highlighting data according to predefined criteria or grouping data according to a grouping criteria.

In an aspect, step (v) further includes storing the generated appearance data, optionally interrelated with the respective provided digital representation of the effect coating and optionally further meta data and/or user input, on a data storage medium, in particular in a database. Storing the generated appearance data optionally interrelated with the provided digital representation and optionally further meta data and/or user input allows to retrieve the stored appearance data the next time it is required and thus allows to increase the speed of displaying the generated appearance data. The stored data may be associated with a user profile and may be retrieved based on the user profile. The further meta data and/or user input may include user comments, user rankings, sorting of generated appearance data by the user according to a sorting criterion, such as a favorite list, etc. The further meta data and/or user input may be used to retrieve the generated appearance data from the database.

Steps (i) to (v) may be repeated using a digital representation of the effect coating being different from the digital representation(s) of the effect coating provided in the first run of step (i). In this case, only part of the appearance data generated upon repeating steps (i) to (v) may be displayed or the displayed appearance data may be updated upon repeating steps (i) to (v) as previously described.

The inventive method allows to generate and display appearance data of effect coatings in a way which allows to optimally compare different effect coating layers by:
using the same ordered list of measurement geometries, the same lightness scaling factor s_{L} and the same pixel resolution for all generated color image(s),
merging the color image with the texture layer such that the resulting display image contains the main characteristics of the effect coating, i.e. the angle-dependent color travel as well as the visual texture, instead of using a combination of color image(s) and texture values which do not convey spatially resolved information (e.g. distribution, size distribution, lightness distribution) or color information, and
displaying the generated appearance data side by side in horizontal arrangement such that each line of the displayed appearance data belongs to the same measurement geometry associated with the same aspecular angle, thus allowing a 1:1 comparison of all horizontally displayed appearance data.

Instead of a horizontal display of the generated appearance data, the generated appearance data can be transposed by swapping the x- and y-axis to allow a comparison in vertical arrangement, for example on the screen of a smartphone. The display images for color matching can be generated ad-hoc requiring low hardware resources and can be easily incorporated into colorimetric applications or web applications used for color matching purposes.

Moreover, the inventive method allows to ad-hoc generate high-quality images of effect coatings in a defined resolution with low hardware resources which can be used as preview images, icons etc. in colorimetric applications and web applications.

### Embodiments of the Inventive System

The system may further comprise at least one color measurement device, in particular a spectrophotometer, such as a multi-angle spectrophotometer previously described. The reflectance data and texture images and/or texture characteristics determined with such spectrophotometers at a plurality of measurement geometries may be provided to the computer processor via a communication interface and may be processed by the computer processor as previously described in connection with the inventive method. The computer processor may be the same computer processor performing steps (ii) and (iii) or may be a different computer processor. The communication interface may be wired or wireless.

The system may further comprise at least one database containing digital representations of effect coatings. In addition, further databases containing color tolerance equations and/or data driven models and/or color solutions as previously described may be connected to the computer processor via communication interfaces.

### Embodiments of the Inventive Use for Color Comparison and/or for Color Communication

Color communication may include discussion of a color (e.g. the visual impression of the color) with a customer during color development or quality control checks. The generated appearance data may be used to provide high-quality images to the customer such that the customer can get an impression of the appearance of the effect coating under different illumination conditions to decide whether the color fulfils the visual requirements and/or required quality. Since the color of the generated appearance data can be easily adjusted by adjusting the texture contrast scaling factor, slight color variations can instantly be presented to the customer and discussed with the customer.

The generated appearance data may be used as button, icon, color preview, for color comparison and/or for color communication in colorimetric applications and/or web applications.

### Embodiments of the Inventive Client Device

The server device is preferably a computing device configured to perform steps (ii) to (iv) of the inventive method.

Further embodiments or aspects are set forth in the following numbered clauses:
1. A computer-implemented method for displaying the appearance of at least one effect coating on the screen of a display device, said method comprising:
   (i) providing to a computer processor via a communication interface at least one digital representation of an effect coating, each digital representation including CIEL*a*b* values of the effect coating obtained at a plurality of measurement geometries, wherein the plurality of measurement geometries includes at least one gloss measurement geometry and at least one non-gloss measurement geometry;
   (ii) generating—with the computer processor—color image(s) by calculating corresponding CIEL*a*b* values for each pixel in each created image based on
      an ordered list of measurement geometries generated from the digital representation(s) provided in step (i) and
      the digital representation(s) provided in step (i) or—if the at least one L*value included in at least one provided digital representation is greater than 90—scaled digital representation(s);
   (iii) generating—with the computer processor—appearance data of the effect coating(s) by adding a texture layer pixel-wise to each generated color image using a lightness scaling factor s_{L}, an aspecular-dependent scaling function sf_{aspecular} and optionally a texture contrast scaling factor s_{c};
   (iv) optionally repeating steps (ii) and (iii) with an ordered list of measurement geometries being different from the ordered list of measurement geometries used in step (ii);
   (v) displaying on the screen of the display device the generated appearance data of the effect coating(s) received from the processor.
2. The method according to clause 1, wherein the display device comprises an enclosure housing the computer processor performing steps (ii) and (iii) and the screen.
3. The method according to clause 1, wherein display device and the computer processor performing steps (ii) and (iii) are configured as separate components.
4. The method according to any one of the preceding clauses, wherein the effect coating consists of a single effect coating layer or wherein the effect coating comprises at least two coating layers, wherein at least one coating layer is an effect coating layer and the at least one further coating layer is a basecoat layer and/or a tinted clearcoat layer and/or a clearcoat layer.
5. The method according to any one of the preceding clauses, wherein steps (ii), (iii) and (v) are performed simultaneously.
6. The method according to any one of the preceding clauses, wherein each digital representation of the effect coating may further comprise texture image(s) of the effect coating, texture characteristics of the effect coating, such as coarseness characteristics and/or sparkle characteristics, the layer structure of the effect coating, the color name, the color code, a unique database ID, a bar code, a QR code, mixing formulae, formulation(s) of the coating material(s) used to prepare the effect coating, a color ranking, a matching or quality score, a price, or a combination thereof.
7. The method according to any one of the preceding clauses, wherein providing at least one digital representation of the effect coating comprises
   determining CIEL*a*b* values and optionally texture image(s) and/or texture characteristics of an effect coating at a plurality of measurement geometries with a measuring device and providing the determined CIEL*a*b* values, the determined texture images(s) and texture characteristics and the used measurement geometries optionally in combination with further meta data and/or user input via the communication interface to the computer processor, and
   optionally obtaining at least one further digital representation of an effect coating based on the provided determined CIEL*a*b* values and optionally based on the determined texture image(s) and/or texture characteristics and/or further meta data and/or user input and providing the obtained at least one further digital representation of the effect coating via the communication interface to the computer processor.
8. The method according to clause 7, wherein obtaining at least one further digital representation of an effect coating based on the provided determined CIEL*a*b* values and optionally based on the determined texture image(s) and/or texture characteristics and/or further meta data and/or user input includes determining with the computer processor best matching colorimetric values, in particular best matching CIEL*a*b* values.
9. The method according to clause 8, wherein the computer processor determining best matching colorimetric values, in particular CIEL*a*b* values, is the computer processor used in steps (ii) and (iii).
10. The method according to clause 8 or 9, wherein determining best matching colorimetric values, in particular CIEL*a*b* values, includes determining best matching color solution(s) and associated matching colorimetric values, in particular matching CIEL*a*b* values, calculating the color differences between the determined CIEL*a*b* values and each matching colorimetric values, in particular CIEL*a*b* values, to define color difference values and determine if the color difference values are acceptable.
11. The method according to clause 10, wherein determining best matching color solution(s) and associated matching colorimetric values, in particular CIEL*a*b* values, is further defined as searching a database for the best matching color solution(s) based on the determined CIEL*a*b* values and/or the provided digital representation.
12. The method according to clause 10 or 11, wherein determining if the color difference values are acceptable includes using a data driven model parametrized on historical colorimetric values, in particular CIEL*a*b*values, and historical color difference values or includes using a color tolerance equation.
13. The method according to any one of clauses 1 to 6, wherein providing at least one digital representation of the effect coating comprises providing effect coating identification data, obtaining the digital representation of the effect coating based on the provided effect coating identification data and providing the obtained digital representation.
14. The method according to clause 13, wherein obtaining the digital representation of the effect coating includes retrieving the digital representation of the effect coating based on the provided coating identification data and providing the retrieved digital representation via the communication interface to the computer processor.
15. The method according to clause 13 or 14, wherein effect coating identification data may include color data of the effect coating, color data of the effect coating with a color and/or texture offset, data being indicative of the effect coating or a combination thereof.
16. The method according to any one of the preceding clauses, wherein the at least one gloss measurement geometry includes aspecular angles of 10° to 30°, in particular of 15° and 25°.
17. The method according to any one of the preceding clauses, wherein the at least one non-gloss measurement geometry includes aspecular angles of greater or equal to 40°, preferably of 70° to 110°, in particular of 75°.
18. The method according to any one of the preceding clauses, wherein the plurality of measurement geometries includes aspecular angles of 10 to 110°, preferably of 10° to 80°, in particular of 15°, 25°, 45° and 75°.
19. The method according to any one of the preceding clauses, wherein step (i) further includes displaying the provided digital representation(s) of the effect coating layer on the screen of the display device.
20. The method according to any one of the preceding clauses, wherein all created images have an identical resolution, preferably an identical resolution in the range of 160×120 pixels to 720×540 pixels, in particular an identical resolution of 480×360 pixels.
21. The method according to any one of the preceding clauses, wherein calculating the corresponding CIEL*a*b* values for each pixel in each created image includes correlating one axis of each created image with the generated ordered list of measurement geometries and mapping the ordered list of measurement geometries and associated digital representation or scaled digital representation, in particular the associated CIEL*a*b* values or scaled CIEL*a*b* values, to the correlated row in the created image.
22. The method according to any one of the preceding clauses, wherein calculating the corresponding CIEL*a*b* values for each pixel in each created image includes using an identical generated ordered list of measurement geometries for all provided digital representations which are to be compared to each other.
23. The method according to any one of the preceding clauses, wherein generating the ordered list of measurement geometries from the provided digital representation(s) includes
   selecting at least one pre-defined measurement geometry from the plurality of measurement geometries contained in each provided digital representation and optionally sorting the selected measurement geometries according to at least one pre-defined sorting criterium if more than one measurement geometry is selected, and
   optionally calculating the accumulated delta aspecular angle for each selected measurement geometry if more than one measurement geometry is selected.
24. The method according to clause 23, wherein the predefined measurement geometry includes at least one gloss measurement geometry and at least one non-gloss measurement geometry or at least one, in particular exactly one, intermediate measurement geometry.
25. The method according to clause 24, wherein the intermediate measurement geometry corresponds to an aspecular angle of 45°.
26. The method according to any one of clauses 23 to 25, wherein the at least one pre-defined sorting criterium includes a defined order of measurement geometries.
27. The method according to clause 26, wherein the defined order of measurement geometries is selected such that a visual 3D impression is obtained if the color image resulting from step (ii) is displayed on the screen of the display device.
28. The method according to clause 26 or 27, wherein the defined order of measurement geometries is 45°>25°>15°>25°>45°>75° or −15°>15°>25° >450>75°>110°.
29. The method according to any one of clauses 23 to 28, wherein the at least one pre-defined measurement geometry and/or the at least one pre-defined sorting criterium is retrieved by the computer processor from a data storage medium based on the provided digital representation(s) of the effect coating and/or further data.
30. The method according to any one of clauses 23 to 29, wherein the delta aspecular angle is the absolute difference angle between the aspecular angle associated with a selected measurement geometry and the aspecular angle associated with the following selected measurement geometry.
31. The method according to any one of the preceding clauses, wherein color image(s) are generated based on scaled digital representation(s) if the at least one L*value included in at least one provided digital representation is greater than 95, in particular greater than 99.
32. The method according to any one of the preceding clauses, wherein each scaled digital representation is obtained prior to generating the color image(s) by scaling all L* color values included in the digital representations provided in step (i) using at least one lightness scaling factor s_{L}.
33. The method according to clause 32, wherein the same lightness scaling factor S_{L} is used to scale all L* color values included in the provided digital representations which are to be compared to each other.
34. The method according to clause 32 or 33, wherein the lightness scaling factor S_{L} is based on the maximum measured L* value of the CIEL*a*b* values included in all provided digital representations or based on the maximum measured L*value of the CIEL*a*b* values included in all provided digital representations which are to be compared to each other.
35. The method according to any one of clauses 32 to 34, wherein the lightness scaling factor s_{L} is obtained according to formula (1)

$${s}_{L} = \frac{x}{{L}_{max}} \qquad ( 1 )$$

in which

x ranges from 90 to 100, preferably from 95 to 100, very preferably from 95 to 99, and Lₘₐₓ is the maximum measured L* value of the CIEL*a*b* values included in all provided digital representations or the maximum measured L* value of the CIEL*a*b* values included in all provided digital representations which are to be compared to each other.
36. The method according to any one of the preceding clauses, wherein calculating corresponding CIEL*a*b* values for each pixel in each created image includes using an interpolation method, in particular a spline interpolation method.
37. The method according to any one of the preceding clauses, wherein step (ii) further includes converting the calculated CIEL*a*b* values to sRGB values and optionally storing the sRGB values on a data storage medium, in particular an internal memory.
38. The method according to any one of the preceding clauses, wherein the aspecular-dependent scaling function sf_{aspecular} weights each pixel of the texture layer in correlation with the aspecular angles corresponding to the measurement geometries present in generated ordered list of measurement geometries.
39. The method according to any one of the preceding clauses, wherein the aspecular-dependent scaling function sf_{aspecular} outputs scaling factors S_{aspec} close to 1 for gloss measurement geometries and scaling factors S_{aspec} close to 0 for flop measurement geometries.
40. The method according to any one of the preceding clauses, wherein an aspecular-dependent scaling function sf_{aspecular} of formula (2a) or (2b) is used for ordered lists including at least one gloss measurement geometry and at least one non-gloss measurement geometry in step (iii)

$${sf}_{aspecular} = \frac{( {aspecular}_{max} - aspecular )}{{aspecular}_{max}} \qquad ( 2 a )$$

$${sf}_{aspecular} = {( \frac{( {aspecular}_{max} - aspecular )}{{aspecular}_{max}} )}^{2} \qquad ( 2 b )$$

in which
aspecularₘₐₓ is the measurement geometry in the ordered list corresponding to the highest aspecular angle, and aspecular is the respective measurement geometry of a pixel of the texture layer, and wherein an aspecular-dependent scaling function sf_{aspecular} of Sf_{aspecular}=1 is used for ordered lists including only one measurement geometry or not including any gloss and flop measurement geometries.
41. The method according to any one of the preceding clauses, wherein the lightness scaling factor s_{L} is used in step (iii) corresponds to the lightness scaling factor(s) s_{L} used in step (ii) or is 1 in case no lightness scaling factor s_{L} used in step (ii).
42. The method according to any one of the preceding clauses, wherein the texture contrast scaling factor assumes values of 1, lower than 1 or higher than 1.
43. The method according to any one of the preceding clauses, wherein adding a texture layer pixel-wise to the generated color image(s) using a lightness scaling factor s_{L}, an aspecular-dependent scaling function sf_{aspecular} and optionally a texture contrast scaling factor s_{c} includes
   providing at least one acquired or synthetic texture image,
   generating modified texture image(s) by computing the average color of each provided acquired or synthetic texture image and subtracting the average color from the respective provided acquired or synthetic texture image, and
   adding the respective modified texture image pixel-wise weighted with the lightness scaling factor s_{L}, the aspecular dependent scaling function sf_{aspecular} and optionally the contrast scaling factor s_{c} to the respective generated color image.
44. The method according to clause 43, wherein the at least one acquired texture image is provided by retrieving an acquired texture image, in particular the texture image acquired at a measurement geometry of 15°, from the provided digital representation(s) of the effect coating layer or by retrieving, the acquired texture image, in particular the texture image acquired at a measurement geometry of 15°, from a data storage medium based on the provided digital representation(s) and optionally providing the retrieved texture image.
45. The method according to clause 43, wherein providing at least one synthetic texture image includes:
   creating an empty image,
   providing a target texture contrast cᵥ,
   generating a random number by a uniform or a gaussian random number generator between −cᵥ and +cᵥ for each pixel in the created image and adding the generated random number to each pixel in the created image,
   blurring the resulting image using a blur filter, in particular a gaussian blur filter, and
   optionally providing the resulting synthetic texture image.
46. The method according to clause 45, wherein providing the target texture contrast cᵥ includes retrieving the determined coarseness and/or sparkle characteristics, in particular coarseness characteristics, from the provided digital representation(s) of the effect coating layer and providing the retrieved coarseness and/or sparkle characteristics, in particular coarseness characteristics, as target texture contrast cᵥ.
47. The method according to clause 46, wherein providing the target texture contrast cᵥ includes retrieving the target texture contrast cᵥ from a data storage medium based on the provided digital representation(s) of the effect coating layer and optionally providing the retrieved target texture contrast cᵥ.
48. The method according to any one of clauses 43 to 47, wherein computing the average color of each provided acquired or synthetic texture image includes computing the pixel-wise local average color, in particular computing the pixel-wise local average color with a normalized box linear filter.
49. The method according to any one of the preceding clauses 43 to 48, wherein the respective modified texture image is added pixel-wise weighted with the lightness scaling factor s_{L}, the aspecular dependent scaling function sf_{aspecular} and optionally the texture contrast scaling factor s_{c} to the generated color image(s) using formula (3)

$$AI ( X , Y ) = CI ( X , Y ) + {s}_{L} * {s}_{C} * {sf}_{aspecular} * modified TI ( X , Y ) \qquad ( 3 )$$

in which

AI (X,Y) is the image resulting from addition of the texture layer to the respective generated color image,

CI (X,Y) is the generated color image,

s_{L} corresponds to the lightness scaling factor used to generate the respective color image or is 1 in case no lightness scaling factor is used to generate the respective color image,

s_{c} is the contrast scaling factor,

sf_{aspecular} is the aspecular-dependent scaling function, and

modified TI (X,Y) is the modified texture image.
50. The method according to any one of the preceding clauses, wherein an ordered list of measurement geometries comprising at least one non-gloss and at least one gloss geometry is used in step (ii) and an ordered list of measurement geometries consisting of intermediate geometries is used upon repeating step (ii) or wherein an ordered list of measurement geometries consisting of intermediate geometries is used in step (ii) and an ordered list of measurement geometries comprising at least one non-gloss and at least one gloss geometry is used upon repeating step (ii).
51. The method according to any one of the preceding clauses, wherein steps (iii) and (v) do not include using 3D object data of a virtual object.
52. The method according to any one of the preceding clauses, wherein step (v) includes displaying the generated appearance data which is to be compared in a horizontal arrangement or transposing the generated appearance data which is to be compared and displaying the transposed appearance data in a vertical arrangement.
53. The method according to any one of the preceding clauses, wherein step (v) includes displaying at least part of the generated appearance data in case steps (ii) and (iii) are repeated.
54. The method according to any one of the preceding clauses, wherein step (v) includes updating the displayed appearance data in case steps (ii) to (iv) are repeated.
55. The method according to any one of the preceding clauses, wherein step (v) further includes displaying data associated with the effect coating.
56. The method according to clause 55, wherein data associated with the effect coating is included in the provided digital representation(s) or is retrieved from a data storage medium based on the provided digital representation(s) of the effect coating.
57. The method according to any one of the preceding clauses, wherein step (v) further includes storing the generated appearance data, optionally interrelated with the respective provided digital representation of the effect coating and optionally further meta data and/or user input, on a data storage medium, in particular in a database.
58. The method according to any one of the preceding clauses, further including repeating steps (i) to (v) using a digital representation of the effect coating being different from the digital representation(s) of the effect coating provided in step (i).
59. A system for displaying the appearance of an effect coating on the screen of a display device, said system comprising:
   a communication interface for providing at least one digital representation of an effect coating to a processor, each digital representation including CIEL*a*b* values of the effect coating obtained at a plurality of measurement geometries, wherein the plurality of measurement geometries includes at least one gloss measurement geometry and at least one non-gloss measurement geometry;
   a display device comprising a screen;
   optionally an interaction element for detecting a user input;
   a processor in communication with the communication interface, the interaction element and the display device, the processor programmed to:
      receive via the communication interface the at least one digital representation of an effect coating;
      generate color image(s) by calculating corresponding CIEL*a*b* values for each pixel in each created image based on
         an ordered list of measurement geometries generated from the received digital representation(s) and
         the received digital representation(s) or—if the at least one L*value included in at least one provided digital representation is greater than 90—scaled digital representation(s); and
      generate appearance data of the effect coating(s) by adding a texture layer pixel-wise to each generated color image using a lightness scaling factor s_{L}, an aspecular-dependent scaling function sf_{aspecular} and optionally a texture contrast scaling factor s_{c};
wherein the display device receives the generated appearance data of the effect coating(s) from the processor and displays the appearance of the effect coating(s).
60. The system according to clause 59 further comprising at least one color measurement device, in particular a spectrophotometer.
61. The system according to clause 59 or 60 further comprising at least one database containing digital representations of effect coatings.
62. A non-transitory computer-readable storage medium, the computer-readable storage medium including instructions that when executed by a computer, cause the computer to perform the steps according to the method of any of clauses 1 to 58.
63. Use of appearance data generated according to the method of any of clauses 1 to 58 or with the system of any one of clauses 59 to 61 as button, icon, color preview, for color comparison and/or for color communication.
64. Use according to clause 63, wherein the appearance data is used in colorimetric applications and/or web applications.
65. A client device for generating a request to determine the appearance of an effect coating at a server device, wherein the client device is configured to provide a digital representation of at least one effect coating and optionally a texture layer to a server device.
66. The client device according to clause 65, wherein the server device is configured to perform steps (ii) to (iv) of the method according to any one of clauses 1 to 58.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIG. 1 is a block diagram of an embodiment of the inventive method for displaying the appearance of at least one effect coating on the screen of a display device;

FIG. 2 illustrates a system in accordance with the invention

FIG. 3 illustrates client server setup for the inventive method

FIG. 4 illustrates the calculation of accumulated delta aspecular angles for an ordered list of measurement geometries (above) and the mapping of an ordered list of measurement geometries and corresponding accumulated delta aspecular angels to a normalized Y-coordinate (below);

FIG. 5 illustrates the mapping of an ordered list of measurement geometries and corresponding image rows of an image having a resolution of 480×360 pixels to measurement geometries sorted in ascending order

FIG. 6 illustrates color images obtained for an ordered list of measurement geometries for directional illumination conditions (above) and for diffuse illumination conditions (below)

FIG. 7 illustrates displayed appearance data generated by adding a texture layer generated from a measured texture image to the respective color image of FIG. 6

FIG. 8 illustrates displayed appearance data generated by adding a synthetic texture layer generated using a target texture contrast cᵥ to the respective color image of FIG. 6

FIG. 9a is a planar view of a display device comprising a screen populated with generated appearance data of a target effect coating and best matching effect coatings generated with the inventive method and system using directional illumination conditions and further meta data

FIG. 9b is a planar view of a display device comprising a screen populated with generated appearance data of a target effect coating and best matching effect coatings generated with the inventive method and system using diffuse illumination conditions and further meta data

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

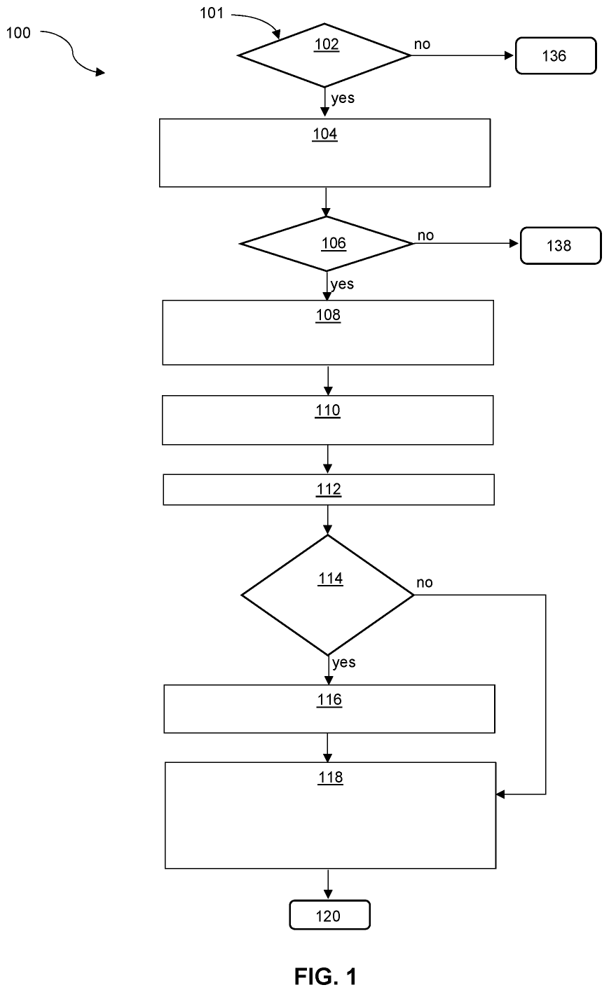

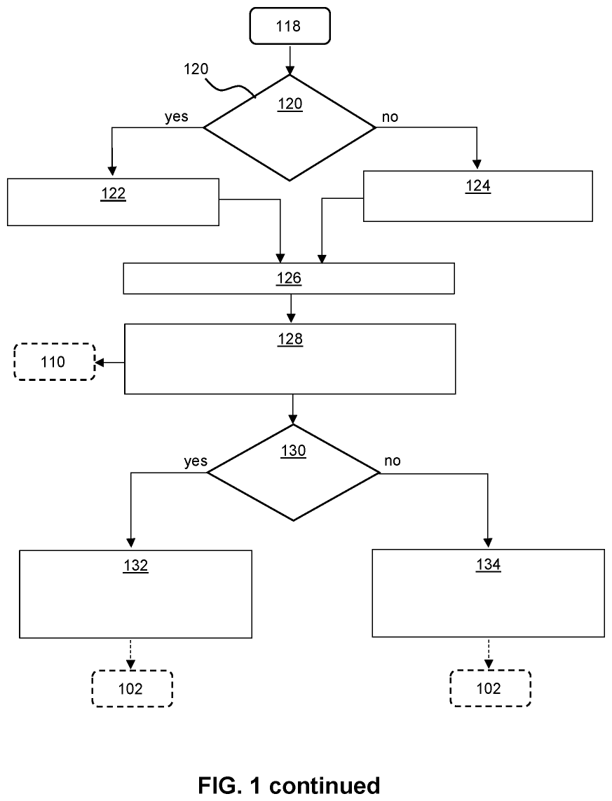

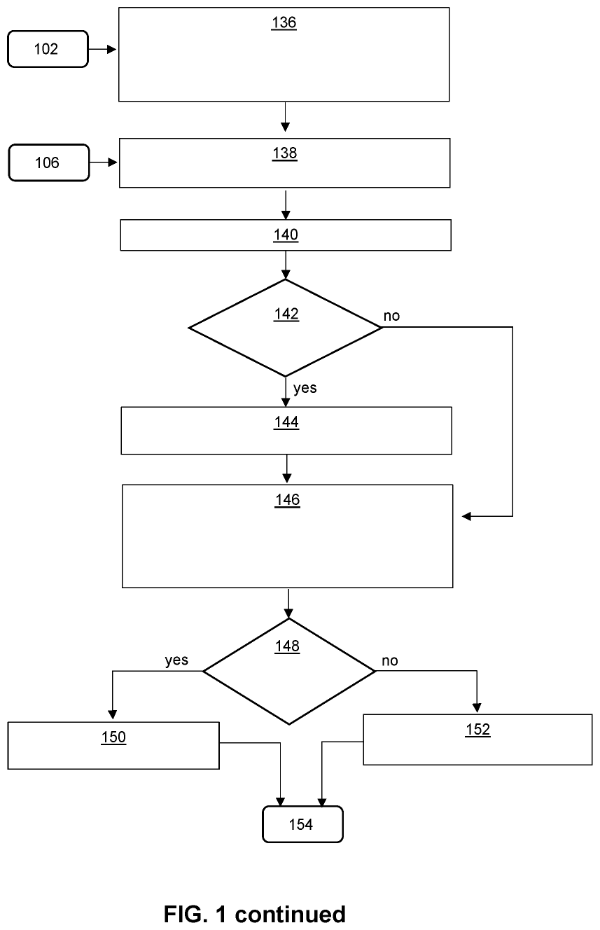

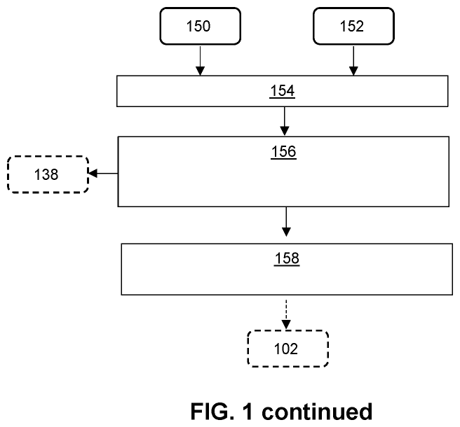

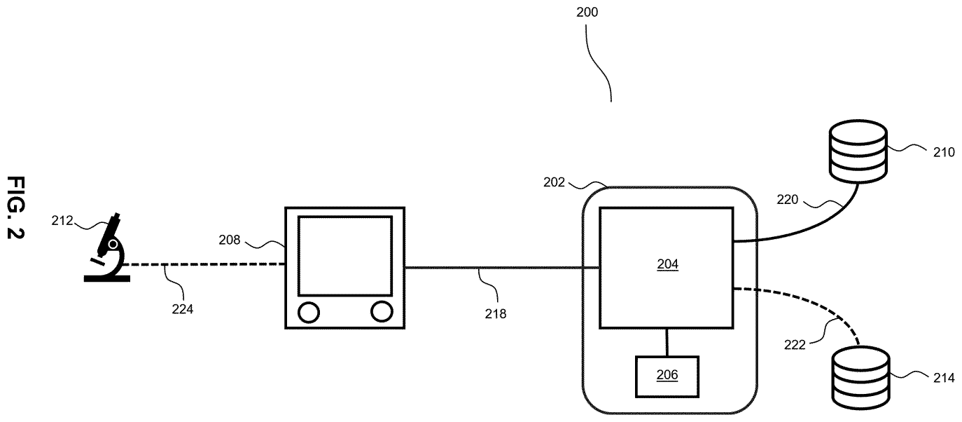

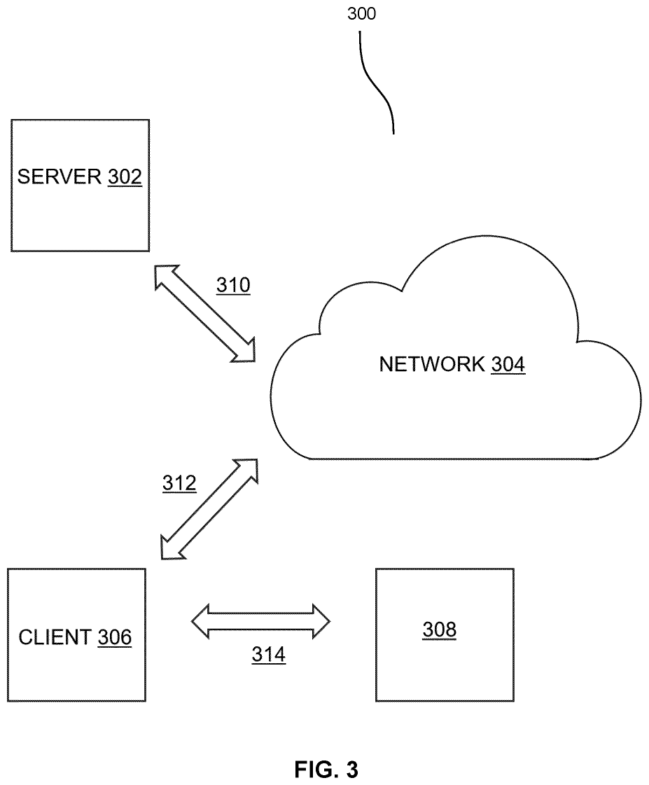

FIG. 1 depicts a non-limiting embodiment of a method 100 displaying the appearance of an effect coating on the screen of a display device according to the invention. In this example, the effect coating a multilayer coating comprising a basecoat layer comprising at least one effect pigment and a clearcoat layer and the display device is a mobile display device having an LCD screen, such as a tablet or laptop. In another example, the display device is a stationary device, such as a stationary computer. In this example, the processor used to generate the color image(s) and the appearance data is present separately from the display device, for example on a cloud computing device being coupled to the display device via a wireless communication interface as depicted in FIG. 3. In another example, the processor used to generate the color image(s) and the appearance data is present within the display device.

In block 102 of method 100, routine 101 determines whether the color and/or the texture of the effect coating is to be determined, for example by measuring the color and/or texture using a multi-angle spectrophotometer as previously described. In one example, a graphical user interface (GUI) is displayed where the user can make the appropriate selection and routine 101 detects the selection and proceeds to block 104 or 136 depending on the user selection. In another example, routine 101 detects acquisition of measurement data or the provision of determined CIEL*a*b* values and optionally texture images and/or texture characteristics and automatically proceeds to block 104.

If it is determined in block 102 that the color and/or the texture is to be determined, routine 101 proceeds to block 104. In case no color and/or texture of an effect coating is to be determined—for example if preview images of different effect coatings based on already existing CIEL*a*b* and texture images or texture characteristics are to be displayed as preview images within a list, as an icon or a button—routine 101 proceeds to block 136 described later on.

In block 104, the color and/or texture of the effect coating is determined using a multi-angle spectrophotometer as previously described and the determined CIEL*a*b* values and/or texture images and/or texture characteristics and the used measurement geometries optionally along with further meta data and/or user input is provided to the processor via the communication interface. The CIEL*a*b* values can be determined at each measurement geometry including at least one gloss and non-gloss measurement geometry from the reflectance data acquired at the respective measurement geometry. Suitable measurement geometries of commercially available multi-angle spectrophotometers, such as the Byk-Mac® I or a spectrometer of the XRite MA®-T-family, include viewing angles of −15°, 15°, 25°, 45°, 75° and 110°, each measured relative to the specular angle. In one example, the spectrophotometer is connected to the display device via a communication interface and the processor of the display device determines the CIEL*a*b* values and/or the texture characteristics. The texture characteristics, i.e. the coarseness characteristics (also called coarseness values hereinafter) under diffuse conditions and/or the sparkle characteristics under directional illumination conditions, can be determined, for example, from gray scale images acquired with said spectrophotometers as described in “Den Gesamtfarbeindruck objektiv messen”, Byk-Gardner GmbH, JOT 1.2009, vol. 49, issue 1, pp. 50-52. In another example, the acquired data (i.e. reflectance data and texture images) is processed by a processing unit being different from the display device and/or the processor used to generate the color images and the appearance data. In this case, the determined CIEL*a*b* values and/or texture images and/or texture characteristics as well as the used measurement geometries are provided to the display device and/or the processor used to generate the color images and the appearance data via a communication interface.

In block 106 of method 100, routine 101 determines whether a color matching operation is to be performed, i.e. whether at least one matching color solution is to be determined based on the provided CIEL*a*b* values and optionally texture images and/or texture characteristics and/or further meta data and/or user input. In one example, a graphical user interface (GUI) is displayed where the user can make the appropriate selection and routine 101 detects the selection and proceeds to block 108 or 138 depending on the user selection.

If it is determined in block 106 that a color matching operation is to be performed, routine 101 proceeds to block 108. If no color matching is to be performed—for example if only the determined CIEL*a*b* values and texture images or texture characteristics are to be used to generate appearance data and display the generated data—routine 101 proceeds to block 138 as described later on.

In block 108, routine 101 obtains at least one further digital representation (called drf hereinafter) based on the CIEL*a*b*values and optionally based on the texture images and/or texture characteristics and/or further meta data and/or user input provided in block 104 (i.e. data associated with the target effect coating) and provides the obtained digital representations (i.e. data associated with color solutions) to the processor. The number of further digital representations obtained in block 108 may be determined based on a predefined color tolerance threshold and/or a predefined texture tolerance threshold and/or a predefined number. In one example, exactly two further digital representations are provided and include the best matching digital representation as well as a digital representation being associated with a matching color and being frequently or recently used by the user or having been recently included in the database. The provided further digital representation(s) include CIEL*a*b* values and optionally further data described in connection with the digital representation of the effect coating. In this example, the at least one further digital representation is obtained by determining best matching CIEL*a*b* values with the computer processor. The computer processor may be the same computer processor used to generate the color image(s) and the appearance data or may be a further computer processor which may be located in a cloud environment (see for example FIG. 3). Best matching CIEL*a*b* values are determined by determining best matching color solution(s) and associated matching CIEL*a*b* values, calculating the differences between the determined CIEL*a*b* values and each matching CIEL*a*b* values to define color difference values and determining if the color difference values are acceptable. In one example, the acceptability of the color difference values is determined using the previously described color tolerance equations. In another example, the acceptability of the color difference values is determined using a data driven model parametrized on historical colorimetric values, in particular CIEL*a*b* values, and historical color difference values, as described, for example, in US 2005/0240543 A1. In case the further digital representations are determined using a processor being different from the processor used to generate the color image(s) and the appearance data, the determined further digital representations are provided via a communication interface to this processor. In case the same processor is used to determine the further digital representations and generate the color image(s) and the appearance data, the determined further digital representations do not have to be provided to the processor prior to performing the blocks described in the following.

In block 110, routine 101 generates an ordered list of measurement geometries from the measurement geometries provided in block 104. The ordered list of measurement geometries is generated by selecting at least one pre-defined measurement geometry from the plurality of measurement geometries contained in each provided digital representation, optionally sorting the selected measurement geometries according to at least one pre-defined sorting criterium if more than one measurement geometry is selected, and optionally calculating the accumulated delta aspecular angle for each selected measurement geometry if more than one measurement geometry is selected.

In one example, the pre-defined measurement geometry is an intermediate measurement geometry, such as 45°. In this case, only one measurement geometry is selected, and no sorting is required. Selection of an intermediate measurement geometry allows to generate appearance data under diffuse illumination conditions (e.g. cloudy weather conditions).

In another example, the predefined measurement geometries include at least one gloss geometry, such as 15 and 25° and at least one non-gloss measurement geometry, such as 45° and/or 75° and/or 110°. The selected pre-defined measurement geometries are then sorted according to a pre-defined sorting criterium, such as a defined order of measurement geometries. In one example, a defined order of 45°>25°>15°>25°>45°>75° is used. In another example, a defined order of −15°>15° >25°>45°>75°>110° is used. The pre-defined measurement geometry/geometries and/or the pre-defined sorting criterium may be retrieved from a database based on the data provided in block 104 or further data, such as the user profile, prior to generating the ordered list. After sorting the selected pre-defined measurement geometries according to the pre-defined sorting criterium, the delta aspecular angle is calculated for each selected measurement geometry as described previously (see for example the previously listed table).

In block 112, routine 101 generates empty images with defined resolutions for the target coating layer (corresponding to the CIEL*a*b* values provided in block 104) and each provided color solution (i.e. the further digital representations provided in block 108). All generated empty images preferably have the same resolution to allow a 1:1 comparison of the target coating layer with the color solution(s) without a negative influence on the generated appearance data which is due to the use of different resolutions of the target and the solution. The resolution may vary greatly and generally depends on the resolution of the color and texture data acquired using a multi-angle spectrophotometer. In one example, all generated empty images have a resolution of 480×360 pixels. It should be mentioned that the order of blocks 110 and 112 may also be reversed, i.e. block 112 may be performed prior to block 110.

In block 114, routine 101 determines whether at least one L*value included in the CIEL*a*b* values of the target coating provided in block 104 or included in the color solutions provided in block 108 is higher than 95. If it is determined in block 114 that at least one L*value of all L*values provided in blocks 104 and 108 is higher than 95, routine 101 proceeds to block 116. If all provided L* values are below 95, routine 101 proceeds to block 118.

In block 116, routine 101 scales all provided L* values using the lightness scaling factor s_{L} previously described with x=95 to obtain scaled digital representations. Use of this lightness scaling factor allows to retain the color information contained in the gloss measurement geometries by compressing the color space while the existing color distances are kept constant. In this example, the same lightness scaling factor S_{L} is used for scaling all provided L* color values provided in blocks 104 and 108. This guarantees that any visual differences in the appearance data, in particular in the regions associated with gloss measurement geometries, is not due to the use of different lightness scaling factors s_{L} and thus results in generated appearance data optimized for visual comparison during color matching operations.

In block 118, routine 101 generates color images for the target effect coating and for each provided color solution by calculating the corresponding CIEL*a*b values for each pixel of each image generated in block 112 based on the ordered list of measurement geometries generated in block 110 and CIEL*a*b* values provided in blocks 104 and 108 or the scaled digital representations obtained in block 116. The calculated CIEL*a*b* values are then converted to sRGB values and stored in an internal memory of the processing device performing this block. In this example, the corresponding CIEL*a*b* values for each pixel of the generated image are calculated by correlating one axis of each image with the ordered list of measurement geometries generated in block 110 and mapping the generated ordered list of measurement geometries and associated CIEL*a*b* values or scaled CIEL*a*b* values of the target effect coating and of the color solution(s) to the correlated row in the respective created image. For example, the color image for the target effect coating, i.e. for the CIEL*a*b* values determined and provided in block 104, is obtained by correlating the y-axis of the image generated in block 112 with the list of measurement geometries generated in block 110 and mapping the generated ordered list of measurement geometries and associated CIEL*a*b* values provided in block 104 or scaled CIEL*a*b* values obtained in block 116 to the correlated row in the generated image. This process is repeated for each color solution provided in block 108 by using the images generated in block 112 and the same ordered list of measurement geometries. In one example, block 118 is performed by the processor of the display device. In another example, block 118 is performed by a processor located separate from the display device, for example located within a cloud computing environment. Shifting the processing requiring a larger amount of computing resources and/or access to different databases to a further computing device allows to use display devices with low hardware resources and/or restricted access rights. At the end of block 118, a color image for the target effect coating as well as color images for each color solution provided in block 108 have been generated with routine 101.

In block 120, routine 101 determines whether an acquired or synthetic texture image for the target effect coating and each color solution provided in block 104 and/or block 108 is to be provided. If an acquired texture image is to be provided, routine 101 proceeds to block 122. Otherwise, routine 101 proceeds to block 124 described later on, for example if the data provided in block 104 and/or 108 does not include acquired texture images or texture images cannot be retrieved from a database based on the data provided in block 104 and/or 108.

In block 122, routine 101 provides acquired texture image(s) by retrieving the respective acquired texture image, in particular the texture image acquired at a measurement geometry of 15°, from the digital representation(s) provided in block 104 and/or 108 or by retrieving the respective acquired texture image, in particular the texture image acquired at a measurement geometry of 15°, from a data storage medium based on the digital representations provided in block 104 and/or 108.

In block 124, routine 101 provides synthetic texture image(s) by
creating an empty image having the same resolution as the image generated in block 112,
obtaining a target texture contrast cᵥ,
generating a random number by a uniform or a gaussian random number generator between −cᵥ and +cᵥ for each pixel in the created image and adding the generated random number to each pixel in the created image, and
blurring the resulting image using a blur filter, in particular a gaussian blur filter.

In one example, the target texture contrast cᵥ is provided by retrieving the determined coarseness and/or sparkle characteristics from the digital representations provided in block 104 and/or block 108 and providing the retrieved coarseness and/or sparkle characteristics, in particular coarseness characteristics, as target texture contrast cᵥ. If the digital representations provided in block 104 and/or 108 do not contain texture characteristics, the target texture contrast cᵥ can be obtained by retrieving the target texture contrast cᵥ from a database based on the data provided in block 104 and/or block 108. The target texture contrasts cᵥ stored in the database can be obtained, for example, by associating a defined texture target contrast cᵥ with an amount or a range of amounts of aluminum pigment present in the coating formulation used to prepare the respective effect coating layer and retrieving the respective texture target contrast cᵥ based on the formulation data contained in the data provided in blocks 104 and/or 108.

In block 126, routine 101 generates modified texture images for each acquired or synthetic texture image provided in block 122 and/or 124 by computing the average color of each acquired or synthetic texture image provided in block 122 and/or 124 and subtracting the computed average color from the respective provided acquired or synthetic texture image. The average color of each provided acquired or synthetic texture image can be computed as previously described by adding up all pixel colors of the provided acquired or synthetic texture image and dividing this sum by the number of pixels of the provided acquired or synthetic texture image or by computing the pixel-wise local average color.

In block 128, routine 101 generates appearance data by adding the respective modified texture image generated in block 126 pixel-wise weighted with a lightness scaling factor s_{L}, an aspecular-dependent scaling function sf_{aspecular} and optionally a contrast scaling factor s_{c} to the respective color image generated in block 118. This step is repeated for all color images generated in block 118 using the respective modified texture image generated in block 126.

The aspecular dependent scaling function used in this step has been previously described and weights each pixel of the texture layer in correlation with the aspecular angles corresponding to the measurement geometries present in generated ordered list of measurement geometries. This allows to weight the pixels of the texture layer in correlation with the visual impression of the effect coating layer when viewed by an observer under different measurement geometries and therefore results in generated appearance data closely resembling the visual impression of the effect coating when viewed under real-world conditions.

In one example, the addition is performed according to formula (3) previously described. Thus, the generation of the appearance data does not involve the use of virtual 3D object data and pre-defined illumination conditions as is the case with rendering processes, such as image-based lightning, and can therefore be performed ad-hoc with low computing power. Instead, the visual 3D effect of the generated appearance data for directional illumination conditions is due to the use of an ordered list of measurement geometries comprising at least one gloss and at least one non-gloss measurement geometry in a pre-defined order.

The lightness scaling factor s_{L} used in block 128 corresponds to the lightness scaling factor s_{L} used in block 116, i.e. the same lightness scaling factor s_{L} is preferably used in blocks 116 and 128, or is 1 in case no lightness scaling factor s_{L} used (i.e. block 116 is not performed). Use of the same lightness scaling factor s_{L} in block 128 allows to adjust the lightness of the texture image to the lightness of the color image, thus preventing a mismatch of the color and texture information with respect to lightness.

The use of the texture contrast factor is generally optional and allows to scale the contrast of the texture to visualize color differences, for example by changing the formulation(s) of the coating material(s) used to prepare the effect coating. If a higher or lower texture contrast is desired, the texture contrast factor can be set to values of higher or lower than 1 as previously described. In one example, the processor performing blocks 122 to 128 or 124 to 128 is the same processor used to perform blocks 110 to 118. This processor may be the processor of the display device or may be included in a separate computing device which may be located on a cloud computing environment. Using the same processor reduces the need to transfer the generated color images to another processor prior to generating the appearance data.

In another example, the processor performing blocks 122 to 128 or 124 to 128 is different from the processor used to perform blocks 110 to 118. In this case, the generated color images are transferred to the further processor prior to performing blocks 122 to 128.

After block 128, routine 101 may either return to block 110 and generates color images using a different ordered list of measurement geometries generated in block 110 or may proceed to block 130. Returning to block 110 allows to generate color images for directional illumination conditions (e.g. sunshine conditions) as well as for diffuse illumination conditions (e.g. cloudy weather conditions). The user therefore gets an impression on the appearance of the effect coating under real-world illumination conditions, thus allowing to select the best color match by considering directional as well as diffuse illumination conditions. This reduces visually different appearances of the original coating and the refinished coating under different illumination conditions and thus increased the quality of the refinish process. For OEM applications, this allows to determine whether the generated appearance data results in the desired visual impression under different illumination conditions.

In block 130, routine 101 determines whether the appearance data generated in block 128 is to be displayed horizontally. If this is the case, routine 101 proceeds to block 132, otherwise routine 101 proceeds to block 134. The determination may be made by routine 101 based on the size and/or the aspect ratio of the screen of the display device. For this purpose, routine 101 may determine the size and/or the aspect ratio of the screen of the display device and may proceed to block 132 or 134 depending on the determined resolution.

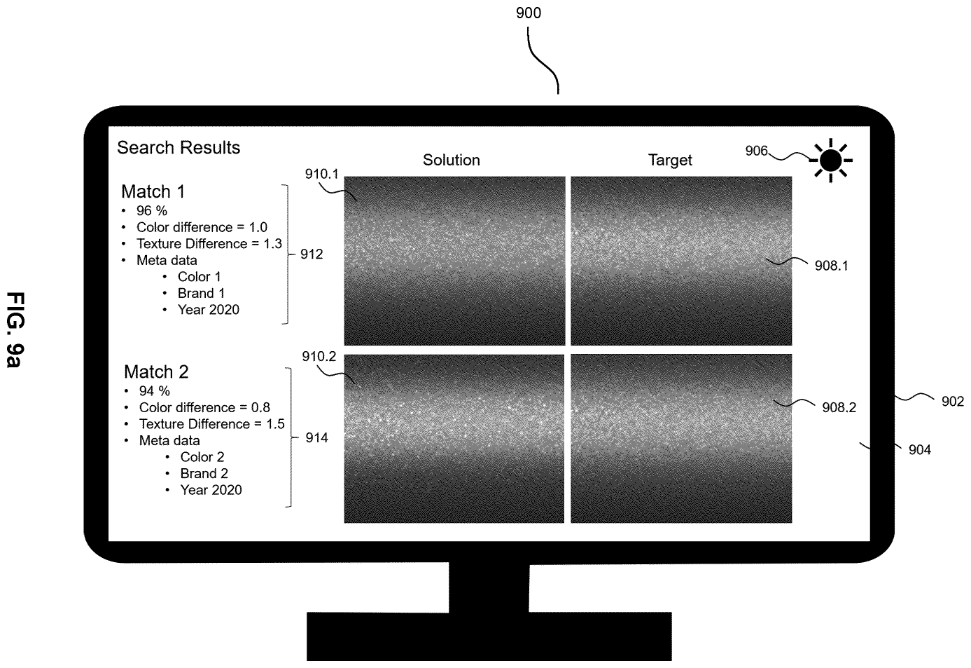

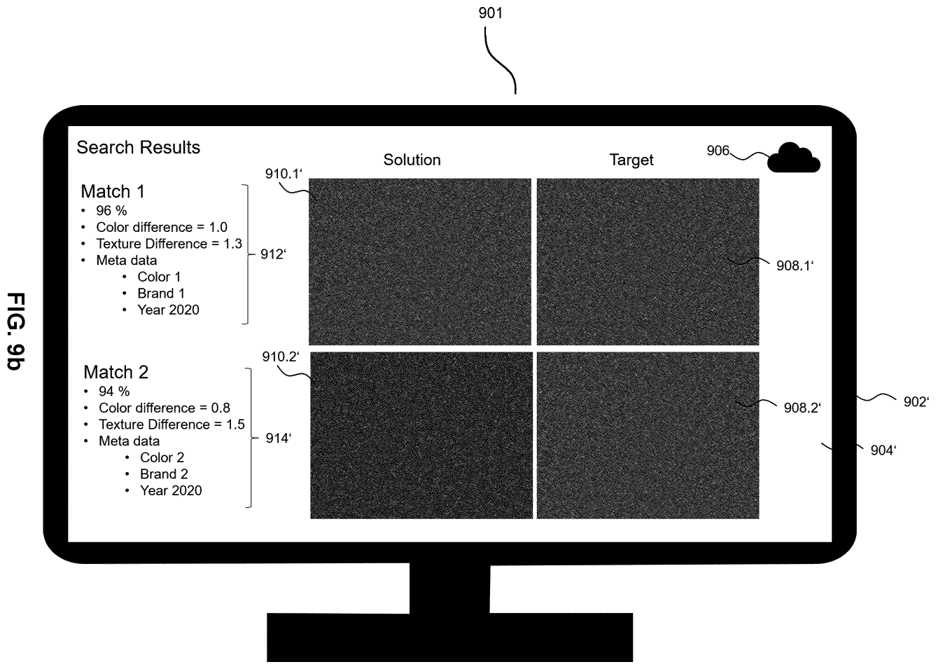

In block 132, routine 101 provides the sRGB files obtained after block 128 to the display device and instructs the display device to display the appearance data for the target effect coating as well as the appearance data for each color solution generated in block 128 horizontally side by side on the screen of the display device. In this horizontal arrangement, each line of the horizontally aligned displayed appearance data belongs to the same measurement geometry associated with the same aspecular angle, thus allowing a 1:1 comparison of the target effect coating with each provided color solution (refer also to FIGS. 9a and 9b). In one example, further data may be displayed next to the appearance data. Further data may include the matching score, the color and/or texture tolerance between the target and the respective solution, meta data (e.g. color name, color number, brand name, color year etc.). Horizontal display is preferred if the screen of the display device has a size of more than 10 inch and/or an aspect ratio of 16:9 or 16:10, such as for example computer screens (mobile or stationary), tablet screens, television screens etc. In one example, the user may select the desired illumination conditions prior to displaying the generated appearance data for the respective illumination conditions. In another example, the appearance data generated using predefined illumination conditions (e.g. directional illumination or diffuse conditions) is displayed as standard and the user may display the appearance data associated with further available conditions upon selection of a respective icon on the screen of the display device.

In block 134, routine 101 transposes the appearance data generated in block 128 by swapping the x- and y-axis of the sRGB files obtained after block 128, provides the transposed sRGB files to the display device and instructs the display device to display the appearance data for the target effect coating as well as the appearance data for each provided color solution generated in block 128 vertically among each other to allow a 1:1 comparison of the target effect coating with each provided color solution. In one example, further data may be displayed as described in block 132. Vertical display is preferred if smartphones are used to display the generated appearance data to ensure that all relevant information can be displayed on the screen without having to scroll during comparison of the generated appearance data for the target effect coating and for each provided color solution. In one example, the user may select the desired illumination conditions prior to displaying the generated appearance data as described in block 132. In another example, the appearance data is generated using predefined illumination conditions and the user may select other available illumination conditions as described in block 132.

The appearance data is generated and displayed in blocks 104 to 132/142 in a way which allows optimal comparison of different effect coatings with respect to color and texture by
using the same ordered list of measurement geometries, the same lightness scaling factor (if necessary) and the same pixel resolution for all color images generated in block 118,
displaying the determined texture characteristics via a texture layer to provide additional information about the visual texture instead of using texture values which do no comprise spatially resolved information or color information, and
displaying the generated appearance data of the target effect coating and the provided color solution(s) side by side in a horizontal arrangement such that each line of the horizontally arranged data is corresponding to the same measurement geometry and associated aspecular angle or
transposing the x- and y-axis of the generated appearance data to allow a vertical arrangement.

After block 132 or 134, routine 101 may return to block 102 upon request of the user. Routine 101 may also be programmed to automatically return to block 102 after the end of block 132.

In block 136, routine 101 retrieves at least one digital representation of the effect coating from a database based on provided effect coating identification data and provides the retrieved digital representation(s) via a communication interface to the computer processor. This block is performed if routine 101 determines in block 102 that no color and/or texture of an effect coating is to be determined, for example with a multi-angle spectrophotometer. In one example, effect coating identification data may include color data (e.g. color space data, texture characteristics) of the effect coating, modified color and/or texture data (e.g. color/texture data with a color and/or texture offset), data being indicative of the effect coating (e.g. layer structure of the effect coating, a color name, a color code, a QR code, a bar code, etc.) or a combination thereof. This data may either be inputted by the user via a GUI or may be retrieved from a data storage medium, such as an internal memory or database.

In block 136, routine 101 generates an ordered list of measurement geometries from the measurement geometries included in the digital representation(s) provided in block 104 or 136 as described in relation to block 110.

In block 138, routine 101 generates empty image(s) with defined resolutions as described in relation to block 112.

In block 142, routine 101 determines whether at least one L*value provided in block 104 or 136 is higher than 95. If yes, routine 101 proceeds to block 144, otherwise, routine 101 proceeds to block 146.

In block 144, routine 101 scales all L* values provided in block 104 or 136 using a lightness scaling factor s_{L} as described in relation to block 116.

In block 146, routine 101 generates color images for each digital representation provided in block 104 or 136 as described in relation to block 118.

In block 148, routine 101 determines whether an acquired or synthetic texture image is to be provided for the digital representations provided in block 104 or 136. If acquired texture images are to be provided, routine proceeds to block 15°, otherwise routine 101 proceeds to block 152.

In block 150, routine 101 provides an acquired texture image(s) by retrieving respective acquired texture image, in particular the texture image acquired at a measurement geometry of 15°, from the digital representation(s) provided in block 104 and/or 136 or by retrieving the respective acquired texture image, in particular the texture image acquired at a measurement geometry of 15°, from a data storage medium based on the digital representations provided in block 104 and/or 136.

In block 152, routine 101 provides synthetic texture image(s) as described in relation to block 124.

In block 154, routine 101 generates modified texture images for each acquired or synthetic texture image provided in block 150 and/or 152 as described in relation to block 126.

In block 156, routine 101 generates appearance data for each digital representation provided in block 104 or 136 by adding the respective modified texture image generated in block 154 pixel-wise weighted with a lightness scaling factor s_{L}, an aspecular-dependent scaling function sf_{aspecular} and optionally a contrast scaling factor so to the respective color image generated in block 146 as described in relation to block 128.

After block 156, routine 101 may either return to block 138 and generates color images using a different ordered list of measurement geometries generated in block 138 or may proceed to block 158. Returning to block 138 allows to generate color images for directional illumination conditions (e.g. sunshine conditions) as well as for diffuse illumination conditions (e.g. cloudy weather conditions) as described previously.

In block 158, routine 101 provides the sRGB files obtained after block 156 to the display device and instructs the display device to display the appearance data generated in block 156. The generated appearance data may be displayed in form of a list which contains further data, such as meta data (e.g. color name, color number, brand name, color year, measurement data, offset values, etc.).

The appearance data is generated and displayed in blocks 136 to 158 in a way which allows ad-hoc generation and display of appearance data showing the main characteristics of effect coating layers by
using the same ordered list of measurement geometries, the same lightness scaling factor (if necessary) and the same defined pixel resolution for all color images generated in block 146, and
displaying the determined texture characteristics via a texture layer to provide additional information about the visual texture instead of using texture values which do no comprise spatially resolved information or color information.

After block 158 routine 101 may return to step 102 upon request of the user. Routine 101 may also be programmed to automatically return to block 102 after the end of block 158.

FIG. 2 shows an example of a system 200 for displaying the appearance of an effect coating on the screen of a display device which may be used to implement blocks 102 and 136 to 156 or blocks 102 to 106 and 136 to 156 of method 10° described in relation to FIG. 1. System 200 comprises a computing device 202 housing computer processor 204 and memory 206. The processor 204 is configured to execute instructions, for example retrieved from memory 206, and to carry out operations associated with the computer system 200, namely
receive via the communication interface at least one digital representation of an effect coating;
generate color image(s) by calculating corresponding CIEL*a*b* values for each pixel in each created image based on
   an ordered list of measurement geometries generated from the received digital representation(s) and
   the received digital representation(s) or—if at last one L*value included in at least one provided digital representation is greater than 90—scaled digital representation(s); and
generate appearance data of the effect coating(s) comprising at least one effect pigment by adding a texture layer pixel-wise to each generated color image using a lightness scaling factor s_{L}, an aspecular-dependent scaling function sf_{aspecular} and optionally a texture contrast scaling factor s_{c}; and
provide the generated appearance data to a display device.

The processor 204 can be a single-chip processor or can be implemented with multiple components. In most cases, the processor 204 together with an operating system operates to execute computer code and produce and use data. In this example, the computer code and data resides within memory 206 that is operatively coupled to the processor 204. Memory 206 generally provides a place to hold data that is being used by the computer system 200. By way of example, memory 206 may include Read-Only Memory (ROM), Random-Access Memory (RAM), hard disk drive and/or the like. In another example, computer code and data could also reside on a removable storage medium and loaded or installed onto the computer system when needed. Removable storage mediums include, for example, CD-ROM, PC-CARD, floppy disk, magnetic tape, and a network component. The processor 204 can be located on a local computing device or in a cloud environment (see for example FIG. 3). In the latter case, display device 208 may serve as a client device and may access the server (i.e. computing device 202) via a network (i.e. communication interface 216).

System 200 further includes a display device 206 which is coupled via communication interface 218 to computing device 202. Display device 206 receives the generated appearance data of the effect coating(s) from processor 204 and displays the received data on the screen, in particular via a graphical user interface (GUI), to the user. For this purpose, display device 206 is operatively coupled to processor 204 of computing device 202 via communication interface 218. In this example, display device 206 is an input/output device comprising a screen and being integrated with a processor and memory (not shown) to form a desktop computer (all in one machine), a laptop, handheld or tablet or the like and is also used to allow user input with respect to coating layer identification data used to retrieve the digital representation(s) of effect coatings from database 210. In another example, the screen of display device 206 may be a separate component (peripheral device, not shown). By way of example, the screen of the display device 206 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like.

The computing device 202 is connected via communication interface 220 to database 210. Database 210 stores digital representations of effect coatings which can be retrieved by processor 204 via communication interface 220. The digital representations stored in said database contain CIEL*a*b* values determined at a plurality of measurement geometries including at least one gloss and non-gloss measurement geometry. In one example, the digital representation may include further data as previously described. The respective digital representations are retrieved from database 210 by processor 204 based on effect coating identification data inputted by the user via display device 206 or effect coating identification data associated with a predefined user action performed on the display device 206, for example by selecting a desired action (e.g. display of a list of stored measurements including display images generated by the inventive method from the measurement data, display of a list of available effect colors, etc.) on the GUI of display device 206

The system may further include a measurement device 212, for example a multi-angle spectrophotometer, such that the system may be used to implement blocks 102 to 132/134 of method 100 described in relation to FIG. 1. The measurement device is coupled via communication interface 224 to display device 206 such that the measured data can be processed by the processor of display device 206. However, it may also be possible that the measured data is processed by a processor included in the measurement device 212 and the processed data is provided to display device 206 via communication interface 224. The data acquired by measurement device 212 is provided via display device 206 to computing device 202 and used to generate the color image(s) and appearance data.

The system may include a further database 214 which is coupled to processor 204 of computing device 202 via communication interface 222. Database 214 contains color tolerance equations and/or data-driven models parametrized on historical colorimetric values, in particular CIEL*a*b* values, and historical color difference values. The data stored in database 214 may be used to determine best matching color solutions from digital representations stored in database 210 or a further database (not shown) as previously described.

Turning to FIG. 3, there is shown an Internet-based system 300 for displaying the appearance of an effect coating on the screen of a display device which may be used to implement method 100 described in relation to FIG. 1. The system 300 comprises a server 302 which can be accessed via a network 304, such as the Internet, by one or more clients 306.1 to 306.n. Preferably, the server may be an HTTP server and is accessed via conventional Internet web-based technology. The clients 306 are computer terminals accessible by a user and may be customized devices, such as data entry kiosks, or general-purpose devices, such as a personal computer. The clients comprise a screen and are used to display the generated appearance data. A printer 308 can be connected to a client terminal 306. The internet-based system is in particular useful, if a service is provided to customers or in a larger company setup. A client may be used to provide the digital representations of effect coatings or effect coating identification data used to retrieve the digital representation(s) of effect coating the computer processor of the server.

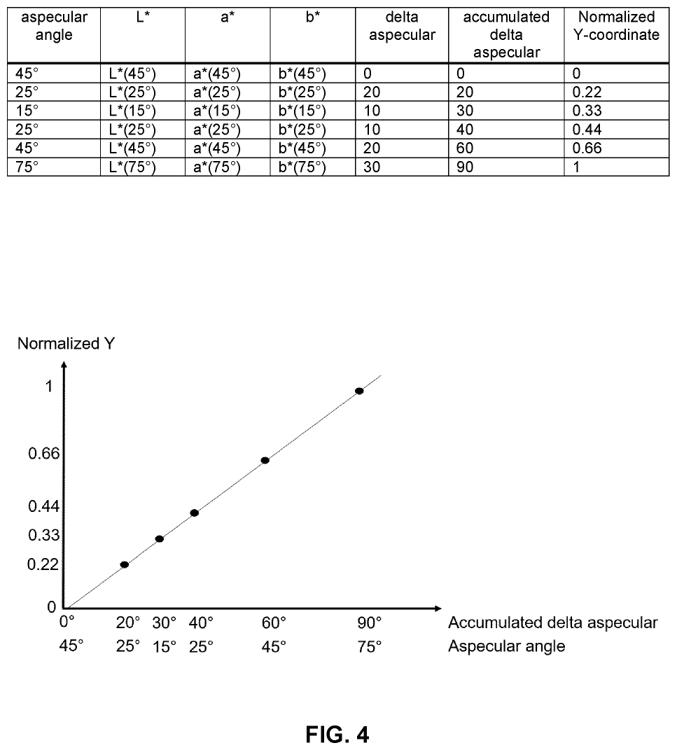

FIG. 4 illustrates the calculation of accumulated delta aspecular angles for an ordered list of measurement geometries (above) and the mapping of an ordered list of measurement geometries and corresponding accumulated delta aspecular angels to a normalized Y-coordinate (below). The calculation of accumulated delta aspecular angles for the ordered list of measurement geometries, i.e. 45°>25°>15°>25°>45° >75°, is performed by calculating the absolute difference between the aspecular angle of the respective measurement geometry and the following measurement geometry for all measurement geometries in the list. For example, the delta accumulated angle associated with the second measurement in the list (i.e. 25°) of the list is obtained by calculating the absolute difference between the first measurement geometry (i.e. 45°) and the second measurement geometry. The accumulated delta specular angle is obtained by adding the delta aspecular angle of the respective to the delta aspecular angle of the following measurement geometry for all geometries in the list. For example, the accumulated delta aspecular angle associated with the third measurement geometry in the list (i.e. 15°) is obtained by adding the delta aspecular angle associated with the 3^{nd} geometry in the list (i.e. 15°) to the accumulated delta aspecular angle associated with the 2^{nd} geometry in the list (i.e. 25°). The normalized Y-coordinate which can be used to correlate the pixels of a created image to the respective aspecular angle (see FIG. 5) can be obtained by dividing the accumulated delta aspecular angle associated with the respective aspecular angle by the maximum accumulated delta aspecular angle (i.e. the accumulated aspecular angle associated with the last measurement geometry in the list—in this example 75°). For example, the normalized Y-coordinate associated with the 2^{nd} measurement geometry (i.e. 25°) can be obtained by dividing the accumulated delta aspecular angle of this measurement geometry (i.e. 20) by the maximum accumulated delta aspecular angle (i.e. 90).

Mapping of the normalized Y-coordinate obtained as previously described to the accumulated delta aspecular angle or the aspecular angle results in a linear relationship. This linear relationship allows to map the ordered list of measurement geometries to the corresponding image rows as described in relation to FIG. 5.

FIG. 5 illustrates the mapping of an ordered list of measurement geometries of FIG. 4 and corresponding image rows of an image having a resolution of 480×360 pixels to measurement geometries sorted in ascending order. The ordered list of measurement geometries, i.e. the associated aspecular angles and normalized Y-axis coordinates (see FIG. 4), are firstly mapped to the respective pixel in the x-axis of the image by multiplying the normalized Y-axis coordinates associated with each aspecular angle in the ordered list with the total amount of pixels present on the x-axis of the image. For example, the 2^{nd} aspecular angle in the ordered list (i.e. an aspecular angle of 25°) has an associated normalized Y-coordinate of 0.22. Multiplication of the total number of pixels in the x-axis (i.e. 360) with this value results in a value of 79.2 which is rounded up to 80. Thus, the aspecular angle of 25° at position 2 of the ordered list is associated with a normalized Y-axis coordinate of 0.22 and an image row of 80. Afterwards, the measurement geometries contained in the ordered list are sorted in an ascending order. FIG. 5 is then obtained by mapping the normalized Y-coordinate, obtained image row and aspecular angle in the ordered list to the measurement geometries sorted in an ascending order. FIG. 5 illustrates that a visual 3D effect can be obtained by using a sorted list of measurement geometries, thus rendering the use of virtual object data and rendering processes to obtain illuminated 3D objects superfluous.

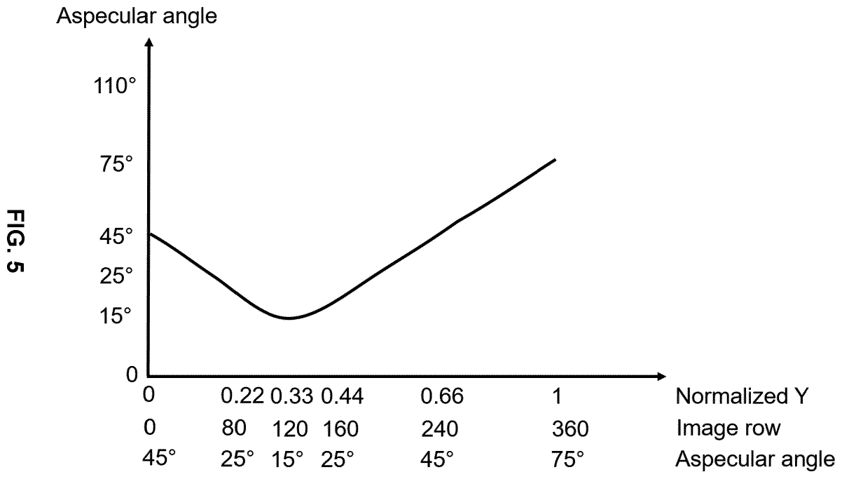

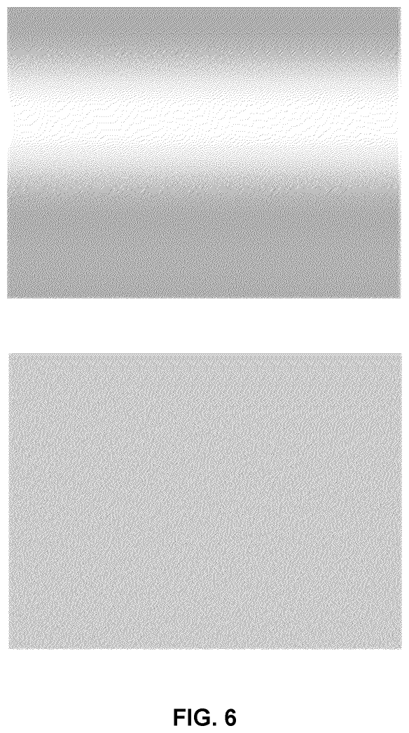

FIG. 6 illustrates color images generated using an ordered list of measurement geometries for directional illumination conditions (above) and for diffuse illumination conditions (below). The ordered list of measurement geometries for directional illumination corresponds the ordered list depicted in FIG. 4. The ordered list of measurement geometries for diffuse illumination conditions used to generate the below color image only contains an aspecular angle (measurement geometry) of 45° (i.e. a single measurement geometry). The color images were generated by creating empty images each having a resolution of 480×360 pixel and calculating corresponding CIEL*a*b*values for each pixel in each created image based on the respective ordered list of measurement geometries and scaled CIEL*a*b* values (because the CIEL*a*b* values associated with the effect coating layer used to generate the color image comprise L* values of more than 95). The corresponding CIEL*a*b* values are obtained by using the mapping shown in FIG. 5 and a spline interpolation method to calculate CIEL*a*b* values for pixels not associated with aspecular angles present in the ordered list of measurement geometries. The calculated CIEL*a*b* values are then transformed to sRGB values and the display images in FIG. 6 are obtained by displaying the respective sRGB values on the screen of a display device. The visual 3D effect of the color image under directed illumination conditions is due to the use of the ordered list of measurement geometries and does not require rendering processes using virtual 3D object data in combination with pre-defined illumination conditions (for example image-based lightning). Thus, high quality color images can be generated ad-hoc without requiring extensive computing power and can be displayed by commonly used screens of display devices without processing the HDR raw data generated during rendering processes.

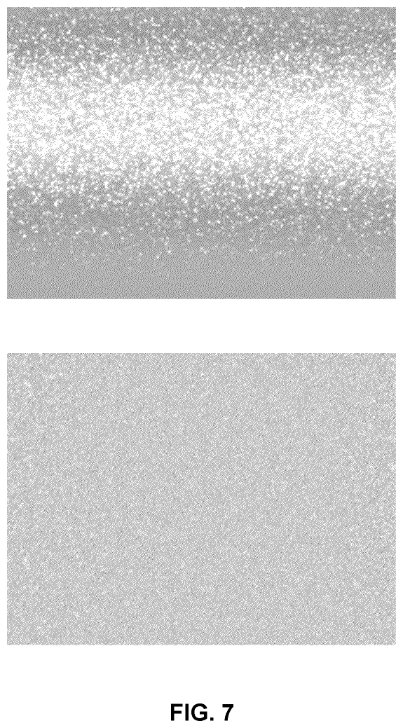

FIG. 7 illustrates displayed appearance data generated by adding a texture layer generated from a measured texture image to the respective color image of FIG. 6. For this purpose, a texture image is generated from the measured texture characteristics as previously described and the generated texture image is modified by computing the pixel-wise local average color of the generated texture image and subtracting the pixel-wise local average color from the generated texture image. The obtained modified texture image is then added pixel-wise weighted with the lightness scaling factor s_{L}, the aspecular dependent scaling function sf_{aspecular} previously described to the respective color image of FIG. 6 according to formula (3) to generate the displayed appearance data. As can be seen from the upper display image of FIG. 7, the use of the aspecular dependent scaling function sf_{aspecular} results in a more pronounced visual texture in regions having high gloss (i.e. in the middle of the displayed image) than in the flop regions (i.e. at the top of the displayed image). The display images contain the main characteristics of the effect coating layer, i.e. the angle-dependent color travel as well as the visual texture, because a visual texture layer is used instead of numerical values which are devoid of spatial information and color information. Use of a texture layer greatly improves the process of visual color matching and allows to identify matching colors more reliably than using a color image in combination with numerical values for the visual texture.

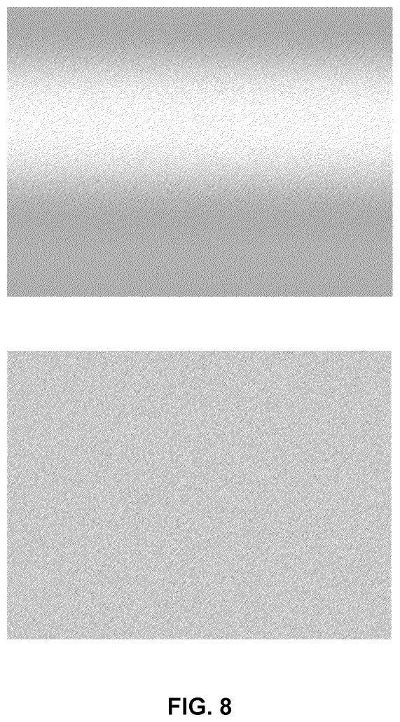

FIG. 8 illustrates displayed appearance data generated by adding a synthetic texture layer generated using a target texture contrast cᵥ to the respective color image of FIG. 6. For this purpose, an empty image having a resolution of 480×360 pixel is created and a target texture contrast cᵥ is provided by retrieving determined coarseness characteristics from the provided digital representation and using the retrieved coarseness characteristics as target texture contrast cᵥ. Afterwards, a random number is generated by a uniform random number generator between −cᵥ and +cy for each pixel in the created image and added to each pixel in the created image. The resulting image is then blurred with a gaussian blur filter. The obtained texture image is then modified and added as a texture layer to the respective color image of FIG. 6 as described in relation to FIG. 7 to generate the appearance data of FIG. 8.

FIG. 9a is a planar view of a display device 900 comprising a screen 902 having a graphical user interface 904. The graphical user interface 904 is populated with generated appearance data of a target effect coating 908.1, 908.2 and best matching effect coatings 910.1, 910.2. The displayed appearance data is generated with the inventive method, for example by performing blocks 102 to 132 described in relation to FIG. 1, and the inventive system, for example the system described in relation to FIG. 2, using directional illumination conditions (i.e. the ordered list of measurement geometries of FIG. 4). Symbol 906 is used to indicate to the user that the displayed appearance data has been generated using directional illumination conditions (e.g. sunshine conditions). The generated appearance data of the target coating 908.1/908.2 (i.e. the CIEL*a*b* values determined and provided in block 104 of FIG. 1) and each identified solution 910.1 and 910.2 (i.e. the color solutions provided in block 108) are displayed horizontally side by side such that each line of the displayed images 908.1-910.1 and 908.1-910.2, respectively, belongs to the same measurement geometry and associated aspecular angle. This allows a visual 1:1 comparison of the identified color solution and the target effect coating and thus increases user comfort during visual color matching. Moreover, the displayed images contain the main characteristics of the target effect coating and the color solution, i.e. the angle-dependent color travel as well as the visual texture, allowing to visually identify the best matching color solution based on the displayed images instead of using texture tolerance equations which do not yield reliable results over the whole range of available effect colors. In this example, further data, such as the overall matching quality, the color and texture difference between target and solution, and further meta data (e.g. color name, brand name, year) is displayed in areas 912, 914 next to each horizontally displayed appearance data for the target effect coating and the color solutions.

FIG. 9b is a planar view of a display device 901 comprising a screen 902′ having a graphical user interface 904′. The graphical user interface 904′ is populated with generated appearance data of a target effect coating 908.1′, 908.2 and best matching effect coatings 910.1′, 910.2′ which were generated with the inventive method, for example by repeating blocks 110 to 132 described in relation with FIG. 1, and the inventive system, for example the system described in relation to FIG. 2, using diffuse illumination conditions (i.e. the ordered list of measurement geometries only contains an intermediate measurement geometry of 45°). Symbol 906′ is used to indicate to the user that the displayed appearance data has been generated used diffuse illumination conditions (e.g. cloudy weather conditions). The generated appearance data of the target coating 908.1′/908.2′ (i.e. the CIEL*a*b* values determined and provided in block 104 of FIG. 1) and each identified solution 910.1′ and 910.2′ (i.e. the color solutions provided in block 108) are displayed horizontally side by side as described in relation to FIG. 9a. Further data is displayed in areas 912′, 914′ as described in relation to FIG. 9a. The user may change between the generated appearance data for directional illumination conditions and the generated appearance data for diffuse illumination conditions to determine whether the best color match under directional illumination conditions provides the required matching quality under diffuse illumination conditions.

1. A computer-implemented method for displaying the appearance of at least one effect coating on the screen of a display device, said method comprising:
(i) providing to a computer processor via a communication interface at least one digital representation of an effect coating, each digital representation including CIEL*a*b* values of the effect coating obtained at a plurality of measurement geometries, wherein the plurality of measurement geometries includes at least one gloss measurement geometry and at least one non-gloss measurement geometry;
(ii) generating—with the computer processor—color image(s) by calculating corresponding CIEL*a*b* values for each pixel in each created image based on
an ordered list of measurement geometries generated from the digital representation(s) provided in step (i) and
the digital representation(s) provided in step (i) or—if at least one L*value included in at least one provided digital representation is greater than 90—scaled digital representation(s);
(iii) generating—with the computer processor—appearance data of the effect coating(s) by adding a texture layer pixel-wise to each generated color image using a lightness scaling factor s_{L}, an aspecular-dependent scaling function sf_{aspecular} and optionally a contrast scaling factor s_{c};
(iv) optionally repeating steps (ii) and (iii) with an ordered list of measurement geometries being different from the ordered list of measurement geometries used in step (ii); and
(v) displaying on the screen of the display device the generated appearance data of the effect coating(s) received from the processor.

2. The method according to claim 1, wherein providing at least one digital representation of the effect coating comprises
determining CIEL*a*b* values and optionally texture image(s) and/or texture characteristics of an effect coating at a plurality of measurement geometries with a measuring device and providing the determined CIEL*a*b* values, the determined texture images(s) and texture characteristics and the used measurement geometries optionally in combination with further meta data and/or user input via the communication interface to the computer processor, and
optionally obtaining at least one further digital representation of an effect coating based on the provided determined CIEL*a*b* values and optionally based on the determined texture image(s) and/or texture characteristics and/or further meta data and/or user input and providing the obtained at least one further digital representation of the effect coating via the communication interface to the computer processor.

3. The method according to claim 1, wherein providing at least one digital representation of the effect coating comprises providing effect coating identification data, obtaining the digital representation of the effect coating based on the provided effect coating identification data, and providing the obtained digital representation.

4. The method according to claim 1, wherein calculating the corresponding CIEL*a*b* values for each pixel in each created image comprises correlating one axis of each created image with the generated ordered list of measurement geometries and mapping the ordered list of measurement geometries and associated digital representation or scaled digital representation to the correlated row in the created image.

5. The method according to claim 1, wherein generating the ordered list of measurement geometries from the provided digital representation(s) comprises
selecting at least one pre-defined measurement geometry from the plurality of measurement geometries contained in each provided digital representation and optionally sorting the selected measurement geometries according to at least one pre-defined sorting criterium if more than one measurement geometry is selected, and
optionally calculating the accumulated delta aspecular angle for each selected measurement geometry if more than one measurement geometry is selected.

6. The method according to claim 5, wherein the defined order of measurement geometries is 45°>25°>15°>25°>45°>75° or −15°>15°>25°>45°>75°>110°.

7. The method according to claim 5, wherein the delta aspecular angle is the absolute difference angle between the aspecular angle associated with a selected measurement geometry and the aspecular angle associated with the following measurement geometry.

8. The method according to claim 1, wherein each scaled digital representation is obtained prior to generating the color image(s) by scaling all L* color values included in the digital representations provided in step (i) using at least one lightness scaling factor s_{L}.

9. The method according to claim 1, wherein the aspecular-dependent scaling function sf_{aspecular} weights each pixel of the texture layer in correlation with the aspecular angles corresponding to the measurement geometries present in generated ordered list of measurement geometries.

10. The method according to claim 1, wherein adding a texture layer pixel-wise to the generated color image(s) using a lightness scaling factor s_{L}, an aspecular-dependent scaling function sf_{aspecular} and optionally a texture contrast scaling factor s_{c} comprises
providing at least one acquired or synthetic texture image,
generating modified texture image(s) by computing the average color of each provided texture image and subtracting the average color from the respective provided texture image, and
adding the respective modified texture image pixel-wise weighted with the lightness scaling factor s_{L}, the aspecular dependent scaling function sf_{aspecular} and optionally the contrast scaling factor s_{c} to the respective generated color image.

11. The method according to claim 1, wherein steps (iii) and (v) do not comprise using 3D object data of a virtual object.

12. A system for displaying the appearance of an effect coating on the screen of a display device, said system comprising:
a communication interface for providing at least one digital representation of an effect coating to a processor, each digital representation including CIEL*a*b* values of the effect coating obtained at a plurality of measurement geometries, wherein the plurality of measurement geometries comprises at least one gloss measurement geometry and at least one non-gloss measurement geometry;
a display device comprising a screen;
optionally an interaction element for detecting a user input; and
a processor in communication with the communication interface, the interaction element and the display device, the processor programmed to:
receive via the communication interface the at least one digital representation of an effect coating;
generate color image(s) by calculating corresponding CIEL*a*b* values for each pixel in created color image based on
an ordered list of measurement geometries generated from the received digital representation(s) and
the received digital representation(s) or—if at least one L*value included in at least one provided digital representation is greater than 90—scaled digital representation(s); and
generate appearance data of the effect coating(s) by adding a texture layer pixel-wise to each generated color image using a lightness scaling factor s_{L}, an aspecular-dependent scaling function sf_{aspecular} and optionally a texture contrast scaling factor se;
wherein the display device receives the generated appearance data of the effect coating(s) from the processor and displays the appearance of the effect coating(s).

13. A non-transitory computer-readable storage medium, the computer-readable storage medium comprising instructions that when executed by a computer, cause the computer to perform the steps according to the method of claim 1.

14. A method of using appearance data generated according to the method of claim 1, wherein the method comprises using the appearance data as button, icon, color preview, for color comparison, and/or for color communication.

15. A client device for generating a request to determine the appearance of an effect coating at a server device, wherein the client device is configured to provide a digital representation of at least one effect coating and optionally a texture layer to a server device.

16. The method according to claim 1, wherein calculating the corresponding CIEL*a*b* values for each pixel in each created image comprises correlating one axis of each created image with the generated ordered list of measurement geometries and mapping the ordered list of measurement geometries and the associated CIEL*a*b* values or scaled CIEL*a*b* values to the correlated row in the created image.
